(19) United States
(12) Patent Application Publication
(10) Pub. No.: US 2018/0267326 A1
(43) Pub. Date: Sep. 20, 2018

(54) METHODS AND SYSTEMS FOR CONTROLLING ANGULAR INTENSITY PATTERNS IN A REAL SPACE 3D IMAGE

(71) Applicant: UNIVERSITY OF ROCHESTER, Rochester, NY (US)

(72) Inventors: Curtis J. Broadbent, Fairport, NY (US); John C. Howell, Jerusalem (IL)

(73) Assignee: UNIVERSITY OF ROCHESTER, Rochester, NY (US)

(21) Appl. No.: 15/761,820

(22) PCT Filed: Sep. 21, 2016
(86) PCT No.: PCT/US2016/052738

§ 371 Date: Mar. 21, 2018

Related U.S. Application Data
(60) Provisional application No. 62/221,304, filed on Sep. 21, 2015.

(51) Int. Cl. G02B 27/22; H04N 13/39; G09G 3/02

(52) U.S. Cl. CPC G02B 27/2271; G02B 2207/114; G09G 3/025; H04N 13/39

(57) ABSTRACT

A system for displaying one or more images in three dimensions. The system has a three dimensional illumination volume containing a gas that emits one or more types of visible light when at certain multi-photon excited states. The system includes lasers (e.g. lasers with beams outside of the visible wavelengths) that can be directed to intersect in the illumination volume to excite particles of the gas to a multi-photon excited state to emit visible light. Scanning the beam intersection (or multiple beam intersections) through the illumination volume generates three dimensional images. In some embodiments, the system includes lasers that can be directed to intersect in the illumination volume to excite particles to an intermediate state that absorbs at least a portion of the emitted radiation from particles excited to a multi-photon excited state.

### CROSS REFERENCE TO RELATED APPLICATIONS

This application claims priority to and the benefit of U.S. Provisional Patent Application 62/221,304 filed Sep. 21, 2015, the contents of which are incorporated herein by reference in their entirety.

### RELATED FIELDS

Systems and methods for generating real space three dimensional images (including static and dynamic images), including laser systems and methods for producing real space three dimensional images using two (or more) photon absorption in gaseous particles.

### BACKGROUND

Currently known three dimensional imaging devices often rely upon optical illusions in an effort to trick the eyes and brain so that the human observer experiences the perception of viewing a three dimensional image. For example, certain passive three dimensional projection techniques involve the use of a projector to project two orthogonally polarized images, and the images sent with each polarization are such that their separation gives the appearance of depth. In another example, certain active three dimensional projectors can operate to project back-to-back images, one for the left eye and one for the right eye. Specially made glasses then rapidly turn on and off the left and right lenses over those eyes, respectively.

Although these and other three dimensional display techniques provide many benefits, still further improvements would be desirable for producing real space three dimensional images. Embodiments of the present invention provide solutions to at least some of these outstanding needs.

### BRIEF SUMMARY

This patent application describes several examples of systems and methods for displaying in three dimensions static or dynamic images using laser beam excitation of gaseous particles. These systems and methods may utilize a three dimensional illumination volume that includes gaseous particles that emit visible light following the absorption of excitation laser energy. These systems and methods may include at least a first laser generating a first laser beam and a second laser generating a second laser beam, and scanners for directing the first and second laser beams to intersect in the illumination volume and excite gaseous particles at the beam intersection to a two-photon excited state, such that visible light is emitted by the particles at the beam intersection. The scanners can further operate to change the positions and/or orientations of the laser beams through the illumination volume so as to change a location of the laser beam intersection in three dimensions.

Light or electromagnetic radiation emitted from the excited gaseous particles at the beam intersections can be arranged and sequenced to generate static or dynamic images. In some cases, the gaseous particles are distributed in a transparent or semi-transparent medium. In some cases, one or more different types of particles can be used to emit light in various colors (e.g. red, green, yellow, blue). Software, hardware, and/or firmware can be used to control laser output and scanning so that light emits from addressable locations of the illumination volume, in a way that forms a static or dynamic three dimensional image that is perceptible to the eye of the viewer.

In one example, a system for displaying one or more images in three dimensions includes: a three dimensional illumination volume comprising a gas, the gas including at least a Rubidium vapor configured to emit a first type of visible light when at a multi-photon excited state; a first laser configured to generate a first laser beam at a first wavelength that is greater than 700 nm or less than 400 nm; a second laser configured to generate a second laser beam at a second wavelength that is greater than 700 nm or less than 400 nm, the second wavelength being different from the first wavelength; and the system configured to direct the first and second laser beams into the illumination volume such that the first and second laser beams intersect in the illumination volume to excite at least some Rubidium particles at the beam intersection to the multi-photon excited state such that the first type of visible light is emitted at the beam intersection.

The system may be configured to excite at least some of the Rubidium particles at the beam intersection to a 5D energy level.

The first type of visible light may include a light emission having a wavelength between 400 nm and 430 nm.

The 5D energy level may be a 5D_{5/2} energy level.

The system may further include a third laser configured to generate a third laser beam at a third wavelength that is different from the first wavelength and the second wavelength, the system configured to direct the first, second and third laser beams into the illumination volume such that the first, second and third laser beams intersect in the illumination volume to excite at least some of the Rubidium particles at the beam intersection to the multi-photon excited state such that the first type of visible light is emitted at the beam intersection.

In another example, a system for displaying one or more images in three dimensions includes: a three dimensional illumination volume including a first atomic or molecular gas configured to emit a first type of visible light when at a multi-photon excited state, the illumination volume further comprising a second buffer gas; a first laser configured to generate a first laser beam at a first wavelength; a second laser configured to generate a second laser beam at a second wavelength, the second wavelength being different from the first wavelength; and the system configured to direct the first and second laser beams into the illumination volume such that the first and second laser beams intersect in the illumination volume to excite at least some particles of the first gas at the beam intersection to the multi-photon excited state such that the first type of visible light is emitted at the beam intersection.

The first gas may include an alkali gas and the second gas may include a noble or inert gas. In some embodiments, the first gas may include a combination of alkali gases and the second gas may include a combination of noble or inert gases. The alkali gas may be a combination of alkali gases, such as Rubidium and Cesium, for example.

The alkali gas may include an atomic Rubidium vapor and the noble gas may include an Argon or Neon gas.

The second gas may include particles of a noble gas at a ground state and the first gas may include particles of the noble gas at a metastable state.

The first gas may include particles of the noble gas at a state in a manifold of metastable states.

The system may produce the particles of the noble gas at the metastable state outside of the illumination volume.

During operation of the system, a power of the first laser may be less than 50 mW and a power of the second laser may be less than 50 mW.

A temperature of the illumination volume during operation of the system may be below 120° C.

The system may be configured to generate in the illumination volume a second type and a third type of visible light, each of the second and third types of visible light having different wavelengths from the first type of visible light.

The system may further include a third laser configured to generate a third laser beam at a third wavelength that is different from the first wavelength and the second wavelength, the system configured to direct the first, second and third laser beams into the illumination volume such that the first, second and third laser beams intersect in the illumination volume to excite at least some of the particles of the first atomic or molecular gas to the multi-photon excited state such that the first type of visible light is emitted at the beam intersection.

The first type of visible light may be emitted at an intermediate transition as the first atomic or molecular gas decays from the multi-photon excited state.

The first atomic or molecular gas may include at least Rubidium particles, the system may be configured to excite at least some of the Rubidium particles at the beam intersection to at least one of a 5D_{3/2} energy level, 6D_{3/2} energy level, 7D_{3/2} energy level, 8D_{3/2} energy level, 9D_{3/2} energy level, 10D_{3/2} energy level, or 11D_{3/2} energy level.

The first atomic or molecular gas may include at least Rubidium particles, the system may be configured to excite at least some of the Rubidium particles at the beam intersection to at least one of a 9D_{5/2} energy level, 10D_{5/2} energy level, or 11D_{5/2} energy level.

The first atomic or molecular gas may include at least Rubidium particles, the system may be configured to excite at least some of the Rubidium particles at the beam intersection to a 11S_{1/2} energy level.

In another example, a system for displaying one or more images in three dimensions includes: a three dimensional illumination volume including a first gas configured to emit a first type of visible light when at a first multi-photon excited state, a second type of visible light when at a second multi-photon excited state, and a third type of visible light when at a third multi-photon excited state, the illumination volume further comprising an inert buffer gas; a plurality of lasers configured to generate a plurality of laser beams, wherein at least some of the laser beams comprise different wavelengths; and the system configured to direct the laser beams into the illumination volume such that at least some of the laser beams intersect at a first beam intersection in the illumination volume to excite at least some particles of the gas at the first beam intersection to the first multi-photon excited state such that the first type of visible light is emitted at the first beam intersection, such that at least some of the laser beams intersect in the illumination volume at a second beam intersection to excite at least some of the particles of the gas at the second beam intersection to the second multi-photon excited state such that the second type of visible light is emitted at the second beam intersection, and such that at least some of the laser beams intersect in the illumination volume at a third beam intersection to excite at least some of the particles of the gas at the third beam intersection to the third multi-photon excited state such that the third type of visible light is emitted at the third beam intersection.

The first gas may be a mixture of gases. For example, the first gas may include a combination of alkali gases and a second gas may include a combination of noble gases.

The mixture of gases may be a mixture of at least three noble gases, wherein each of the three noble gases corresponds to emission of one of the types of visible light.

In additional embodiments, a method of creating a three dimensional image in a three dimensional illumination volume is provided. The three dimensional illumination volume may include at least one gas. The method may include intersecting at least two lasers at a first voxel in the illumination volume such that particles at the first voxel emit radiation in a plurality of directions from the first voxel. Particles at one or more second voxels in the illumination volume may be excited to an intermediate state that absorbs at least a portion of the emitted radiation in at least one of the directions of the emitted radiation.

Optionally, particles at the one or more second voxels may be excited to the intermediate state by using at least one laser to excite the particles to the intermediate state. In some embodiments, particles at the one or more second voxels may be excited to the intermediate state by using at least two lasers to excite the particles to the intermediate state.

Particles at the one or more second voxels may be excited to the intermediate state by exciting the particles to a lower auxiliary state by a first auxiliary laser beam and exciting the particles to an upper auxiliary state by a second auxiliary laser beam. The excited particles at the one or more second voxels may decay from the upper auxiliary state to the intermediate state. The excited particles at the one or more second voxels may not emit visible light when the particles decay from the upper auxiliary state to the intermediate state.

In some embodiments, the gas may include Rubidium gas. The particles at the first voxel may be excited by a first illumination laser beam exciting Rubidium particles from a 5S_{1/2} level to a 5P_{3/2} level and a second illumination laser beam exciting Rubidium particles from the 5P_{3/2} level to an (n>5)D_{5/2} level. The particles at the one or more second voxels may be excited to a 5P_{1/2} level by the first auxiliary laser beam and may be excited to a 4D_{3/2} level by the second auxiliary laser beam. In some embodiments, a portion of the particles excited to the 4D_{3/2} level may decay to the 5P_{3/2} level.

In some embodiments, the method may further include calculating a desired angular intensity pattern.

In additional aspects of the present invention, a method for implementing optical occlusion in a three dimensional imaging system may be provided. The method may include generating an illumination voxel emitting radiation in a plurality of directions. The illumination voxel may be behind a foreground element voxel when viewed from a first perspective along a first viewing axis. The method may further include dynamically controlling an emission angle or an angular intensity pattern of the radiation emitted from the illumination voxel such that radiation emitted by the illumination voxel toward the foreground element along the viewing axis is attenuated. The foreground element may be anything in the foreground relative to the illumination voxel through which light should not normally be able to pass or is attenuated in order for the image to adhere to optical occlusion principles. For example, the foreground element could include a foreground surface or object relative to the illumination voxel. The foreground surface may or may not be visible to the viewer depending on the user's viewing perspective.

The foreground element may be defined by of a plurality of foreground element voxels. The one or more foreground element voxels may be illuminated by intersecting two or more laser beams at locations of each of the foreground illumination voxel element voxels within a container of gas. In some embodiments, the one or more foreground illumination voxels may illuminated by scanning the two or more laser beams through the volume of gas. The method may include dynamically controlling emission angles or angular intensity patterns of the plurality of foreground element voxels when illuminated.

Optionally, the illumination voxel may be generated in an enclosure. The enclosure may be configured to locally control the intensity of transmitted radiation through the enclosure. The enclosure may include liquid crystal light valve arrays. The emission angle or the angular intensity pattern of the illumination voxel may be dynamically controlled by controlling the liquid crystal light valve arrays of the enclosure to adjust transmissivity during illumination voxel generation.

The emission angle or the angular intensity pattern of the illumination voxel may be dynamically controlled by exciting particles between the illumination voxel and the foreground element along the viewing axis to an intermediate state configured to absorb at least a portion of radiation emitted by the illumination voxel along the viewing axis. Particles between the illumination voxel and the foreground element along the viewing axis may be excited to the intermediate state by intersecting two or more laser beams to excite a localized region of particles to the intermediate state.

In further embodiments, a three dimensional display system may be provided. The system may include a three dimensional illumination volume comprising at least one gas configured to emit a visible light when excited from a ground state to a multi-photon excited state. A first illumination laser may be provided that is configured to generate a first illumination laser beam. A second illumination laser may be provided that is configured to generate a second illumination laser beam. A first auxiliary laser may be provided that is configured to generate a first auxiliary laser beam. A second auxiliary laser may be provided that is configured to generate a second auxiliary laser beam. The system may be configured to direct the first illumination beam and the second illumination beam into the illumination volume such that the first illumination beam and the second illumination beam intersect in the illumination volume to excite at least some particles of the gas at the intersection of the first illumination beam and the second illumination beam to the multi-photon excited state such that visible light is emitted at the intersection of the first illumination beam and the second illumination beam. Additionally, the system may be further configured to direct the first auxiliary beam and the second auxiliary beam into the illumination volume such that the first auxiliary beam and the second auxiliary beam intersect in the illumination volume to excite at least some particles of the gas at the intersection of the first auxiliary beam and the second auxiliary beam to an intermediate level such that at least a portion of the visible light emitted at the intersection of the first illumination beam and the second illumination beam is absorbed by the particles of the gas at the intersection of the first auxiliary beam and the second auxiliary beam excited to the intermediate level.

In some embodiments, the first auxiliary laser may be configured to generate the first auxiliary laser beam at a first auxiliary frequency and the second auxiliary laser may be configured to generate the second auxiliary laser beam at a second auxiliary frequency. The first auxiliary frequency in addition to the second auxiliary frequency may be resonant with an energy difference between the ground state and the multi-photon excited state. The first auxiliary laser may be configured to excite particles to a first auxiliary level and the second auxiliary laser may be configured to excite particles from the first auxiliary level to a second auxiliary level. A portion of the particles excited to the second auxiliary level may decay to the intermediate level. In some embodiments, a one-step two-photon process using detuned lasers can promote atoms to the second auxiliary level without necessarily populating the first auxiliary level. This may allow for controlling the angular emission pattern by using detuning to keep some occlusion voxels transparent while neighboring occlusion voxels may be made opaque.

Optionally, the volume of gas comprises Rubidium gas. The first illumination laser beam may be configured to excite Rubidium particles from a 5S_{1/2} level to a 5P_{3/2} level. The second illumination laser beam may be configured to excite Rubidium particles from the 5P_{3/2} level to an (n>5)D_{5/2} level. The first auxiliary laser beam may be configured to excite Rubidium particles to a 5P_{1/2} level. The second auxiliary laser beam may be configured to excite Rubidium particles from the 5P_{1/2} level to a 4D_{3/2} level.

### BRIEF DESCRIPTION OF THE DRAWINGS

FIGS. 1 through 1(g) schematically illustrate non-limiting examples of a three-dimensional imaging system.

FIGS. 2 and 2(a) illustrate non-limiting examples of absorption and emission processes for a three-dimensional imaging system.

FIGS. 3 through 5 schematically illustrate additional non-limiting examples of three-dimensional imaging systems.

FIG. 6 illustrates a non-limiting example of a three-dimensional imaging method.

FIG. 7 illustrates an exemplary method for adjusting an angular emission pattern or intensity pattern of an illumination voxel according to some embodiments of the present invention.

FIG. 8 illustrates a method of exciting particles to emit radiation according to some embodiments of the present invention.

FIG. 9 illustrates an exemplary method for exciting particles to an upper auxiliary level according to some embodiments of the present invention.

FIG. 10 illustrates a method of exciting particles to an upper auxiliary level that may decay to an intermediate level according to some embodiments of the present invention.

FIGS. 11a-11b illustrate an exemplary 3D display situation for the purpose of illustrating occlusion principles and methods and systems of the present invention.

FIG. 12 illustrates an exemplary 2D cross-section through an illumination voxel according to some embodiments of the present invention.

FIG. 13 illustrates a 3×3×3 cube of voxels surrounding an illumination voxel in some non-limiting examples of the present invention.

### DETAILED DESCRIPTION OF THE DRAWINGS

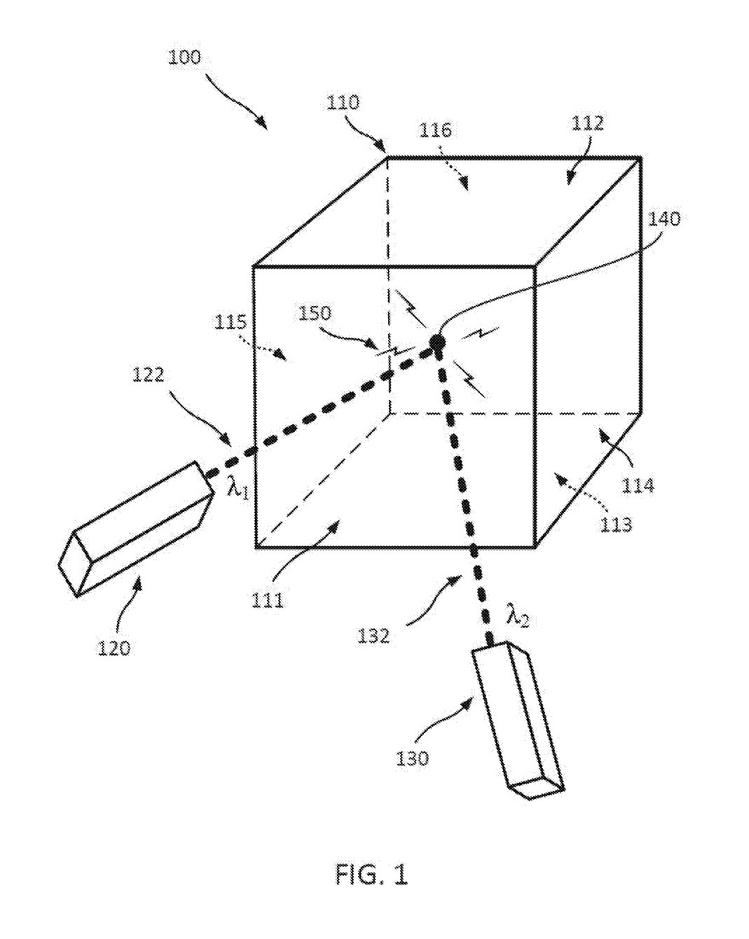

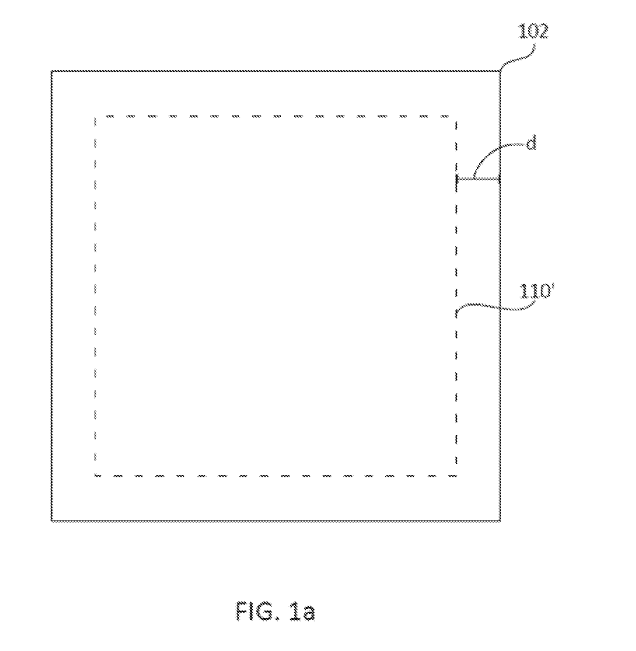

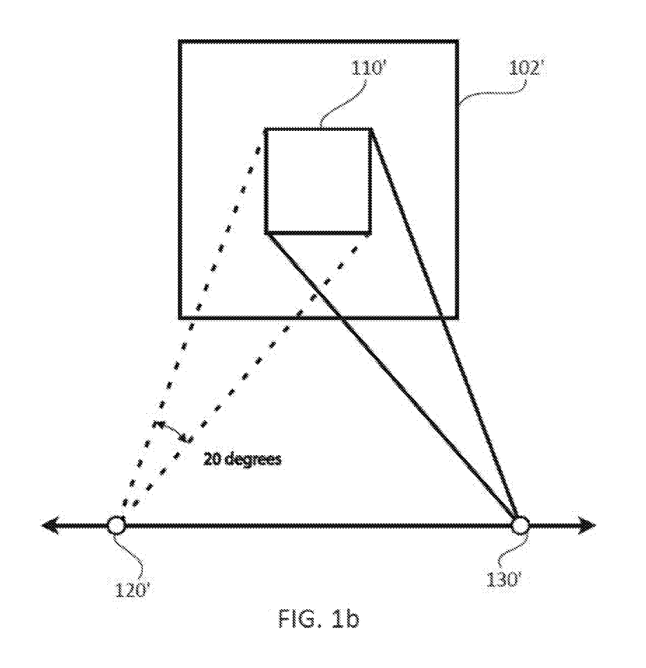

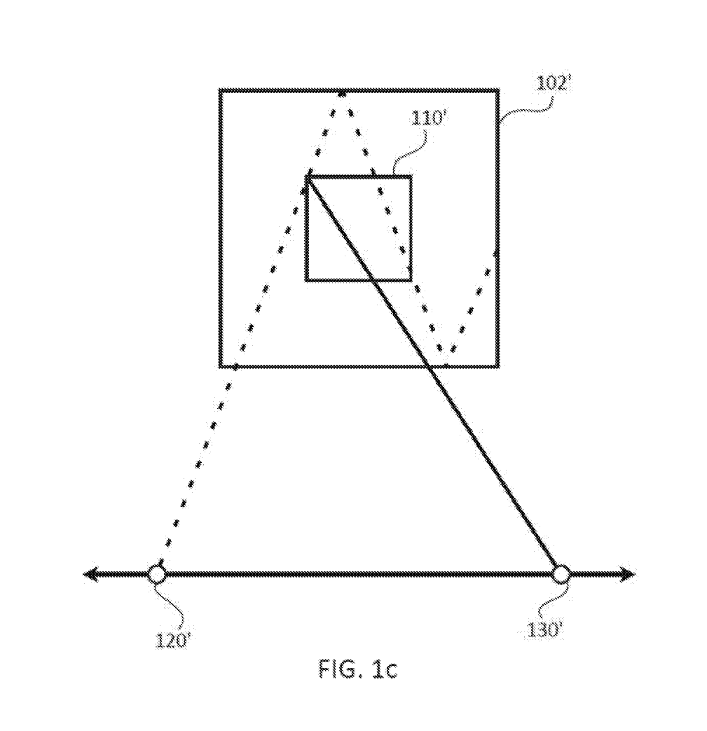

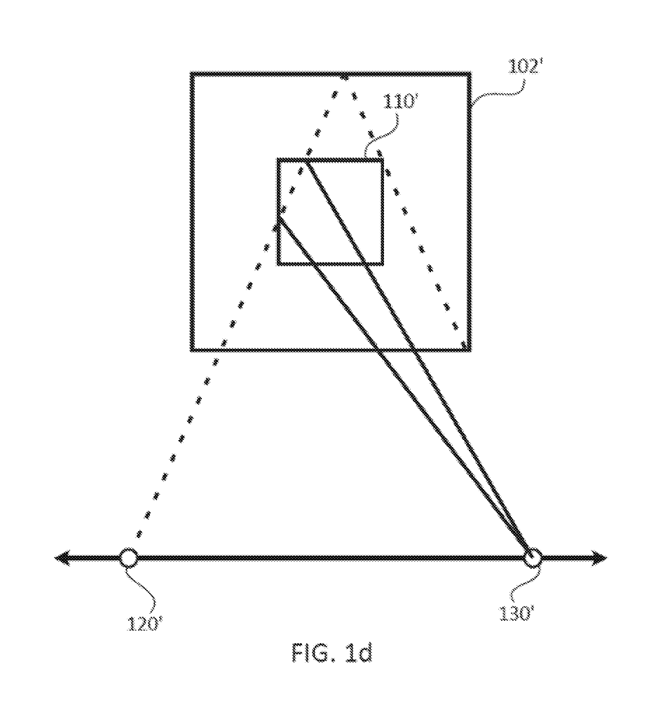

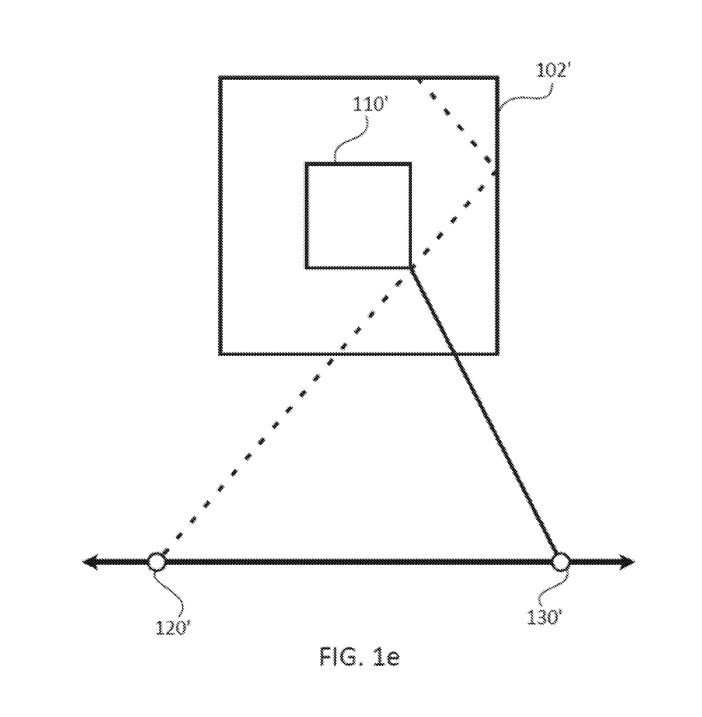

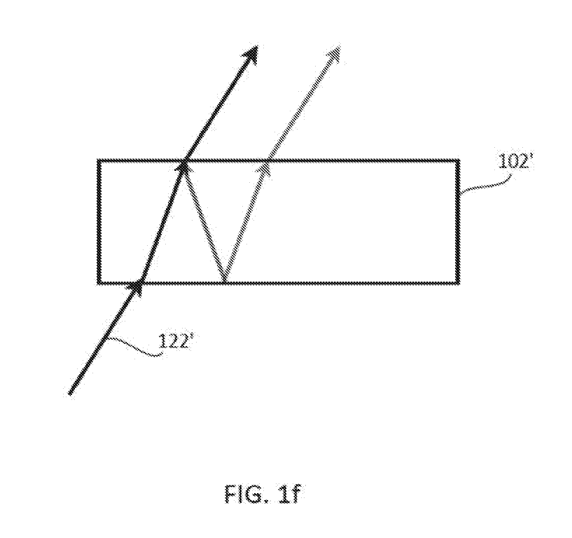

FIG. 1 depicts an example of a three-dimensional imaging system. As shown, the system 100 includes a three dimensional illumination volume 110 having at least one atomic or molecular gas. The atomic or molecular gas can include at least one type of atoms or molecules configured to emit a first type of visible light when at a two-photon excited state. In some cases, the system 100 can include a first laser 120 configured to generate a first laser beam 122 at a first wavelength λ₁ and a second laser 130 configured to generate a second laser beam 132 at a second wavelength λ₂. The second wavelength λ₂ can be different from the first wavelength λ₁.

The human eye has strong spectral sensitivity to light having wavelength values within a range from about 400 nm to about 700 nm. By using two-photon absorption, lasers producing light that is outside the spectral sensitivity of the eye, for example at a wavelength less than about 400 nm or greater than about 700 nm, can excite very small regions of the gas and make the gas emit light at visible wavelengths. Accordingly, the emission from the gas can be observed while the lasers exciting the gas are invisible to the human eye. In other instances, lasers producing light that is within the spectral sensitivity of the eye may be utilized.

System 100 can be configured to direct the first and second laser beams 122, 132 to intersect in the illumination volume 110 to excite at least some of the first type of atoms or molecules at beam intersection 140 to the two-photon excited state, such that a first type of visible light 150 (e.g. a third wavelength λ₃) is emitted at the localized region or beam intersection 140. By changing (e.g. scanning) the location of laser beam intersection 140, 3-dimensional images can be produced in real space and, in some embodiments, changed in time to generate 3-dimensional videos.

### Atomic or Molecular Gas

The illumination volume 110 has gaseous particles dispersed throughout it. In some cases, the particles may be present as a vapor, and may be atoms, molecules (elemental or compound), ions of atoms or molecules, or any combination thereof. In at least some embodiments, the gaseous particles have sufficient kinetic energy to move freely throughout the volume 110. When present within a container, gaseous particles can distribute so that the gas fills the volume of the container. In some cases, the gas within the illumination volume 110 is transparent when not undergoing an absorption/emission process. In some cases, gaseous particles of the illumination volume 110 can be specifically chosen based on their selective absorption of one or more laser wavelengths and emission of one or more visible wavelengths.

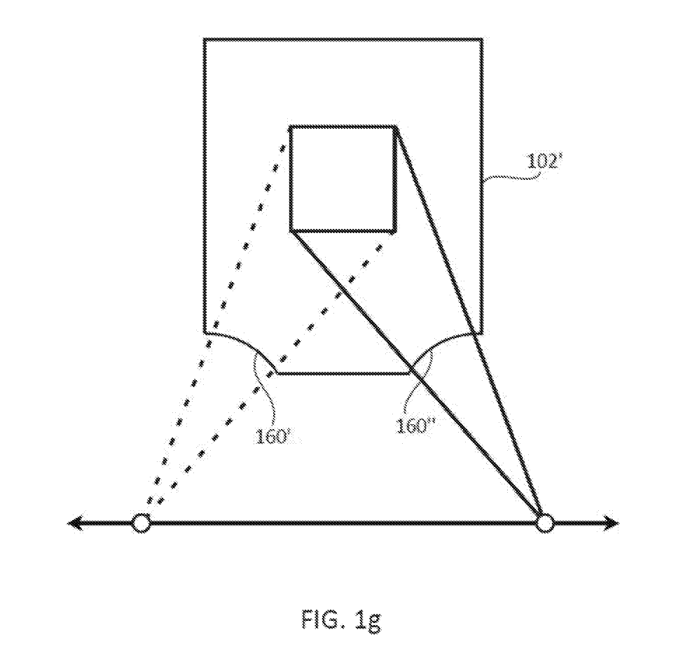

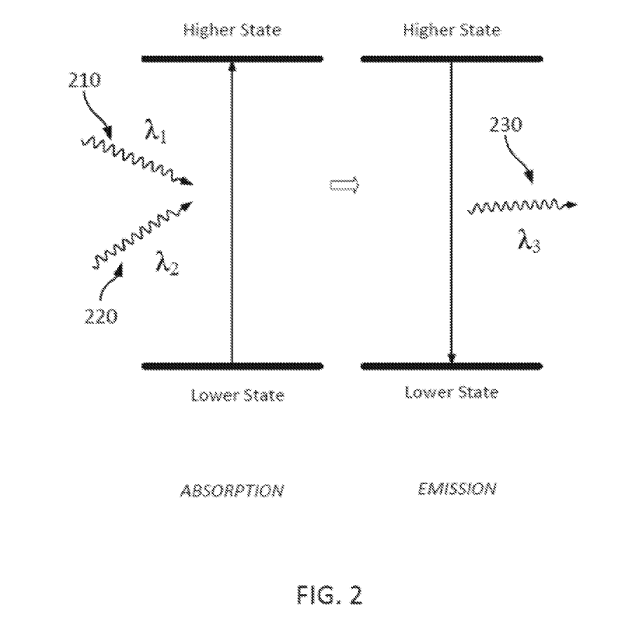

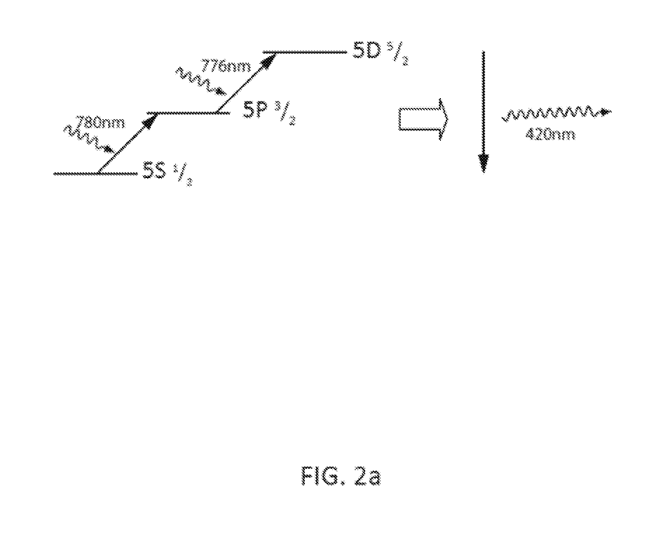

FIG. 2 depicts an example of a particle excitation and emission process that may occur at the laser beam intersection 140 shown in FIG. 1. As shown in this energy level diagram, a first photon 210 at a first wavelength λ₁ or frequency in combination with a second photon 220 at a second wavelength λ₂ or frequency can operate to excite a gaseous particle from a lower state (e.g. a first state or ground state) to a higher state (e.g. a second state or excited state). For example, the two photons can excite an electron of the particle into a higher state (e.g. transitioning from one discrete energy level to another), as the electron absorbs incident energy from the light photons. Following absorption of the two photons and elevation to the higher energy state, the excited electron decays to the lower state while also emitting a photon 230. The emitted light may be at a wavelength λ₃ within the visible spectrum. Although FIG. 2 depicts the lower to higher state transition occurring in a single step, in at least some embodiments, the transition will occur in multiple steps, such as by the first photon 210 causing a transition to an intermediate level and the second photon 220 causing a transition from the intermediate level to the higher level. Although FIG. 2 depicts the higher to lower state transition occurring in a single step, in at least some embodiments, the transition will occur in multiple steps.

In some embodiments, the gas may include an atomic Rubidium (Rb) vapor. FIG. 2 depicts one example of a particle excitation and emission process for atomic Rubidium. In FIG. 2a, a first laser beam at 780 nm excites a 5S_{1/2} to 5P_{3/2} transition, where it will remain for some period of time, and a second laser beam at 776 nm achieves the two-photon transition from the 5P_{3/2} to the 5D_{5/2} states. As shown in FIG. 2(a), when in this two-photon excited state, one spontaneous emission decay pathway emits a blue photon at 420 nm (in this particular case, infrared light is also emitted with the 420 nm light).

While not specifically shown in the figure, in this particular embodiment, the spontaneous emission pathway leading to the emission of 420 nm light proceeds from the 5D_{5/2} state to the 6P_{3/2} state emitting an infrared photon. From the 6P_{3/2} level the light is able to spontaneously emit a blue photon when it decays to the 5S_{1/2} level. There are other decay pathways emitting other light, however, in at least some embodiments, none of those other pathways emit light in the visible range of wavelengths.

In some embodiments, methods may be employed to encourage one particular decay pathway (e.g. the emission of light at a desired wavelength) over other possible decay pathways. For example, additional lasers may be introduced to allow for the use of fourwave mixing to promote decay down the desired decay pathway. In some instances, however, four-wave mixing will not be suitable for a particular embodiment because typically, the phase-matching conditions restrict the angular emission pattern of the emitted light to a very small solid-angle and in a precise and/or restricted angular direction.

In some, although not all, embodiments, the emission pathway depicted in FIG. 2a may be particularly desirable because the dipole matrix elements for these transitions is larger than some other transition pathways for Rb. Larger dipole matrix elements typically means, in at least some instances, that the transition is easier to pump or excite and often means that the particular decay pathway will occur with higher probability than other decay pathways. Larger dipole matrix elements also typically mean shorter excited state lifetimes. Since the number of times an atom can be excited and decay within the dwell time of the scanning lasers is directly related to the intensity of the emitted light, shorter excited state lifetimes can be very beneficial.

In some, although not all, embodiments, the emission pathways employed by the present system may be beneficial over other decay pathways that include decay through the 6P levels. In at least some instances, decay through the 6P level will mean that in addition to generating light at the desired wavelengths, such an approach will also generate light at 420 and 421 nm. Such approaches, in many instances, are unable to generate pure frequencies or wavelengths in the visible range, which may reduce the area of the color gamut which is accessible for a full color display, either RGB, CMYK, or other color mixing methodology.

The example of the excitation and emission process shown in FIG. 2a uses two laser beams of infra-red light (e.g. having a wavelength of approximately 760 nm to 1000 μm). More particularly, in this example, the two laser beams are both in the near infrared spectrum (e.g. having a wavelength of approximately 760 nm to 1500 nm). In other embodiments, other wavelengths outside of the spectrum of light visible to humans (e.g. outside of approximately 400 nm to 700 nm) may be employed. For example, in some embodiments, ultraviolet wavelengths may be employed.

Additional/other pathways than that shown in FIG. 2a may be employed in some embodiments. Some non-limiting examples include pathways ending on the 6D_{5/2}, 7D_{5/2}, 8D_{5/2}, 12D_{5/2} levels, which utilize the 5P_{3/2} intermediate level. Other examples include pathways ending on the 8S_{1/2}, 9S_{1/2}, and 10S_{1/2} levels, which utilize the 5P_{1/2} level. Still other examples include excitation pathways to the (5-12)D_{3/2} levels, the (9-11)D_{5/2} levels, and the 11S1/2 level, which utilize either the 5P_{1/2} or 5P_{3/2} intermediate levels, all of which generate visible light when they decay. Some of these pathways may be preferable to other pathways in certain embodiments. For example, excitation pathways to the (9-11)D_{5/2} levels may have a larger cross-section and branching ratio to the 5P_{3/2} level than the 12D_{5/2} level has to the 5P_{3/2} level. Broadly speaking, the P_{1/2} levels couple nearly as strong to the D_{3/2} levels as the P_{3/2} levels couple to the D_{5/2} levels (as measured by the transition matrix elements). Thus, the (5-12)D_{3/2} levels may be used with nearly the same effectiveness as the D_{5/2} levels in some embodiments. Additionally, the P_{3/2} levels appear to couple to S_{1/2} levels more strongly than at least some of the P_{1/2} levels (e.g. 8-10S_{1/2} to 5P_{1/2}). Levels above the 11S and 12D levels may also be used, however both the cross-section and branching ratio to the 5P levels appear to decrease for higher levels. Since, in at least some embodiments, the design of a suitable display system will depend upon the availability of suitably configured lasers at the various transition wavelengths, identification of all levels which may be used may be an important consideration in constructing a suitable system in at least some instances. U.S. Pat. No. 4,881,068 to Eric J. Korevaar and Brett Spivey identify other pathways that may be utilized in some embodiments, the disclosure of which is incorporated herein by reference. For example, with Cesium vapors, the following transitions may be used:
the 6S_{1/2} level to the 6P_{3/2} level, then the 6P_{3/2} level to the 12-14D_{5/2} level;
the 6S_{1/2} level to the 6P_{1/2} level, then the 6P1/2 level to the 7-14D_{3/2} level;
the 6S_{1/2} level to the 6P_{1/2} level, then the 6P1/2 level to the 12-13 S_{1/2} level;
the 6S_{1/2} level to the 6P_{3/2} level, then the 6P_{3/2} level to the 6D_{5/2} level which may decay to the 7P_{3/2} level via infrared radiation and subsequently to the 6S_{1/2} level via 455 nm radiation; or
the 6S_{1/2} level to the 6P_{1/2} level, then the 6P_{1/2} level to the 6D_{3/2} level which may decay to the 7P_{1/2} level and the 7P_{3/2} level via infrared radiation and subsequently from these to the 6S_{1/2} level via radiation at 455 nm and 459 nm.

In some, although not necessarily all, instances, one issue with excitation and decay pathways that are based on two-transition processes is that it may be difficult to find a scenario where the laser addressing the upper transition can be infrared but the decay pathway creating the desired visible light does not occur on the final decay to the ground state. In the scenario where the visible light is generated on the final transition to the ground state, one potential issue in some instances is a trade-off between having a sufficiently high atomic or molecular number density so that sufficient visible light is generated, but having a sufficiently low density so that the generated light is able to propagate out of the cell without being substantially rescattered. In some embodiments, this trade-off limits the density of the Rb atoms in a practical embodiment. In some embodiments, one solution to this problem is using a buffer gas, which is discussed in greater detail below. On the other hand, in scenarios where the laser addressing the upper transition is at a visible wavelength then the desired fluorescence may occur on the upper transition. Consequently the light is not resonant with the many ground state atoms in the gas and may propagate freely out of the volume. However, a visible laser which is very powerful (as is required to generate lots of fluorescence) can also create a lot of laser scatter that is hard to filter and eliminate. The laser scatter cannot necessarily be filtered easily because it is at nearly the same wavelength as the generated fluorescence. Any attempt to filter laser scatter will also filter the light emanating from the illumination voxel.

In some embodiments, this issue may be addressed by making use of an excitation pathway involving three infrared lasers and using a cascade processes to generate the visible light so that the visible light is created in an intermediate transition in the cascade process. One non-limiting example of this approach which can be used to generate red fluorescence is the excitation pathway: 5S_{1/2}->5P_{3/2}->4D_{5/2}->8P_{3/2} with lasers at 780, 1530, and 953 nm. Decay pathways giving rise to significant amounts visible light in an intermediate transition are as follows: 630 nm light is created via 8P_{3/2}->6D_{5/2}->5P_{3/2}->5S_{1/2} and 8P_{3/2}->6D_{3/2}->5P_{3/2}->5S_{1/2}, 620 nm light is created via 8P_{3/2}->6P_{3/2}->5P_{1/2}->5S_{1/2}, 616 nm is created via 8P_{3/2}->8S_{1/2}->5P_{3/2}->5S_{1/2}, and 607 nm light is created via 8P_{3/2}->8S_{1/2}->5P_{1/2}->5S_{1/2}. As with all other high-lying cascade processes, 420 and 421 nm light is still created from decay pathways that proceed though the 6P levels. Additionally, decay processes through the 7S_{1/2} level will emit some radiation at 728 and 741 nm and decay from the 8P and 7P levels to the 5S level will generate ultraviolet radiation at 335 and 359 nm. The sum of the branching ratios through the five main visible decay pathways around 600 nm is about 25%, whereas the decay pathways giving rise to 420 and 421 nm light have a branching ratio sum of approximately 2%. With a two-laser process up to the 6D_{5/2} level, the branching ratio to the 5P_{3/2} level which generates 630 nm light is 78% with nearly the same branching ratio sum generating 420 and 421 nm light as before. Thus a three-laser excitation process reduces the efficiency of the decay process branching ratios by only a factor of three, but completely eliminates visible laser scatter.

In some embodiments, this approach is used to generate other colors of visible fluorescent light. For example, the excitation pathway 5S_{1/2}->5P_{3/2}->4D_{5/2}->9P_{3/2} makes use of a 780, 1530, and 861 nm lasers. This transition will generate light decaying to the 9S, 8S, 7D, and 6D levels. In Rubidium, decay to the S-levels tends to favor the highest S-level, and decay to the D-levels tends to be equally distributed. Consequently, the emitted light will have frequency components at 557, 565, 572, 607, 616, 620, and 630 nm, with a heavier relative weighting of the green-yellow frequencies (557, 565, and 572 nm). The perceived color is likely to be orange or yellow-orange. Some embodiments using this approach can also be used to generate predominantly green light by excitation up to the 10P, 11P, or 12P levels from the 4D_{5/2} level using lasers at 813, 784, and 764 nm, respectively. This approach can also be used to generate visible fluorescence without using visible lasers in different atomic species.

We note that if continuous wave lasers are used in a saturation condition, the total population in the 8P_{3/2} level will likely be reduced relative to the population which could be excited to the 6D_{5/2} level in a two laser configuration. If pulsed lasers are used, in principle, the entire population in the localized region could be excited to the desired level, either 8P_{3/2} in the three laser process, or the 6D_{5/2} in the two laser process. This can be done using so called “\pi pulses” to sequentially excite the atoms up to the desired excited state. A \pi pulse is a short laser pulse with a specific total area used to fully invert an atomic transition. By applying \pi pulses in sequence the population can be moved sequentially to the desired excited state before population decays significantly from any of the intermediate levels. In some instances, this approach requires precision in the total energy to constitute a \pi pulse. Additionally, in some instances, level degeneracies associated with hyperfine or Zeeman splitting tend to corrupt the process, and Doppler broadening can also reduce the efficiency of the excitation process.

Another alternate approach in some embodiments for efficiently exciting the atoms to the desired level is to use amplitude-modulated stimulated Raman adiabatic passage (AM-STIRAP). In this approach resonant pulses are used in sequence to coherently transfer the atoms between two final states without populating the intermediate state. This approach can be used for both ladder systems and lambda-type systems and can be applied to multi-level systems with more than three levels. The pulse lengths for this process should be much shorter than the decoherence time of the pairs of levels. In a ladder system the decoherence time between pairs of levels is exceedingly short, nevertheless it may be feasible if short laser pulses, including femtosecond, picosecond, or possibly, in some cases, few nanosecond pulses, are used. This approach tends to be robust to level degeneracies [Shore et al. Phys. Rev. A 45, 5297 (1992)].

Still other non-limiting examples of possible excitation pathways include excitation up to the 5F_{7/2} level: 5S_{1/2}->5P_{3/2}->4D_{5/2}->5F_{7/2}. Atoms excited up to the 5F_{7/2} level will decay through the 4, 5, and 6D_{5/2} levels and subsequently through the 5, 6, and 7P_{3/2} levels, respectively, generating visible light at 630 nm and 420 and 421 nm. In this approach, only about 2% of the atoms will decay to the 6D_{5/2} level to emit 630 nm light but greater than 1% will decay through the 6P_{3/2} level to emit 420 nm light.

The approaches described above for generating localized visible fluorescence using two or more lasers can also be generalized to noble gases. Most noble gases can be excited with electronic excitation to the so-called metastable states. Metastable states have the property that they are long-lived states with decay lifetimes far exceeding other levels in the same atom. The metastable states exhibit increased lifetimes because decay to the common ground state is forbidden by standard transition selection rules. Metastable states can function like effective ground states for higher-lying levels above them. For example, in Argon, the are two metastable states, the 3s²3p⁵(²P″_{3/2})4s configuration ²[3/2]″ term J=2 state and the 3s²3p⁵(²P″_{1/2})4s configuration ²[1/2]″ term J=0 state, using notation consistent with the NIST Atomic Spectra Database [Kramida, A., Ralchenko, Yu., Reader, J. and NIST ASD Team (2014). NIST Atomic Spectra Database (version 5.2), [Online], Available: http://physics.nist.gov/asd [Tuesday, 17 Feb. 2015]. National Institute of Standards and Technology, Gaithersberg, Md.] From the 3s²3p⁵(²P″_{3/2})4s configuration ²[3/2]″ term J=2 state a laser at 811.53 nm can excite the atom to the 3s²3p⁵(²P″_{3/2})4p configuration ²[5/2] term J=3 state. Then a visible laser of wavelength of 603 nm can excite the atom to the 3s²3p⁵(²P″_{3/2})5d configuration ²[7/2]″ term J=4 state. It is important to note that metastable states can be excited to states that are able to eventually decay in some instances to the Argon ground state via ultraviolet radiation, which may be undesirable in some, although not necessarily all, embodiments. Using levels that can decay to the ground state is not-preferred in some embodiments because energy is lost but visible light is not created. All of the levels listed above are forbidden from decaying to states which decay to the ground state. As such they constitute what we will call a metastable manifold of states. By this we mean that allowed decay pathways from these states always terminate on the lowest energy metastable state, in this case the 3s²3p⁵(²P″_{3/2})4s configuration ² [3/2]″ term J=2 state. Other excitation pathways may also be envisioned in Argon. For example, instead of using the excited state with the 3s²3p⁵(²P″_{3/2})5d configuration, excitation to the 3s²3p⁵(²P″_{3/2})6d configuration ²[7/2]″ term J=4 state is able to generate green light at 550 nm. Similarly, excitation to the (7-12)D levels (same term and total electron angular momentum as the 4D and 6D states) emits (522, 506, 496, 489, 483, 480) nm light, respectively. This means that using the 5D, 7D, and 12D levels would allow for a full RGB color display in a single noble gas based system. As above, these states are part of the metastable manifold of states. We note that a small amount of ultraviolet light will almost always be generated in these systems from the cascade decay of the excited d state to the 6-12P levels and subsequently to the 4s metastable state. This type of decay can be filtered by using coatings on the display window in addition to being naturally filtered by the display windows themselves.

The similarity of all noble gases, including Neon, Argon, Krypton, Xenon, and Radon, means that if a sequence of levels can be found in one element, there is a nearly equivalent level structure in the other elements, albeit with different transition frequencies and different dipole transition matrix elements. This means, for example, that mixtures of noble gases can be used to generate multiple fully independent colors. In some cases it may be desirable to scan the red, green, and blue colored voxels independently. For this to be possible, in at least some embodiments, the laser driving the lower transition has to be different for each color. In some cases this may be possible with a single atomic species by utilizing different metastable states and intermediate transitions. In other cases it may be advantageous to mix atomic species so that each species creates one or more colors. For example, consider a set of levels in Krypton, with metastable state 4s²4p⁵(²P″_{3/2})5s configuration ²[3/2]″ term J=2, intermediate state 4s²4p⁵(²P″_{3/2})5p configuration ²[5/2] term J=3, and excited state 4s²4p⁵(²P″_{3/2})6d configuration ²[7/2] term J=4 state. The lower transition is accessed with 811.29 nm light, while the upper transition is accessed with and subsequently emits 646 nm light. The (7-12)D levels can be accessed with and emit (583, 552, 534, 522, 515, and 509) nm light, respectively.

Other levels in noble gases besides those mentioned above may be utilized in some embodiments. In some cases, additional decay pathways may be acceptable if the branching ratio through the primary pathway is large enough. Similar to the alkali vapors, excitation to the high-lying s levels can also be considered in noble gases. Additionally, two- or three-laser excitation with cascade emission of visible light can be considered in the noble gases similar to what is discussed above for alkali vapors.

In some embodiments utilizing noble gases, it may be challenging to create a very high density of metastable states without also creating large amounts of visible fluorescence from higher lying levels. In some embodiments, this problem can be surmounted by separating the metastable state creation region from the display volume with an opaque tube of sufficient length. Since higher-lying states decay very quickly, and the metastable states decay very slowly, atoms in higher lying states will decay before leaving the tube while the metastable states will not. In this way only ground state atoms and metastable state atoms will reach the display volume. One feature of using metastable atoms in at least some instances is that any atom in the ground state will act as a buffer gas to the metastable states. More details about buffer gases for some embodiments will be included below.

In some embodiments, metastable state densities close to those used in Alkali systems are possible. Typical methods for producing metastable states of noble gases have an efficiency in the range of 10⁻⁵-10⁻⁴. For Argon at a pressure of 10 Torr at room temperature, an efficiency of 10⁻⁴ corresponds to a metastable state density of 3×10⁻¹³/cm³. This is roughly the same as the density of a Rb vapor heated to about 130° C. The metastable states should be able to fill a large volume because effective lifetime of the metastable state (in the presence of collisions with ground state atoms) is estimated to be a few ms. At room temperature the Ar atoms have a mean velocity of about 400 m/s, so that a metastable state should be able to travel about 400-1200 mm before it relaxes to the ground state. We note that the intrinsic lifetime of the metastable state is actually 38 sec.; the effective lifetime includes collisions so the calculation does not appear to depend upon the mean free path of the metastable Ar states.

In at least some embodiments, the system may be configured to maintain the gas at a desired density in the illumination volume, such as by, for example, heating the gas to a desired temperature by using, for example, a heating system. In one embodiment, a gas including atomic Rubidium can be heated anywhere from room temperature to approximately 150 degrees Celsius to maintain a target density of anywhere between 10¹⁰ to 10¹⁴ atoms/cm³. In other embodiments, including embodiments utilizing inert gasses, heating may be unnecessary to achieve target densities.

In some embodiments, the target density depends on the specific excitation and decay pathways as well as the composition of the atomic vapor. In some embodiments, an inert buffer gas may be used to collisionally broaden the energy levels. As noted above this has the effect in at least some embodiments of drastically improving the efficiency of the excitation and emission processes. Since in some embodiments the goal is to create a practical display that is easily visible in moderate ambient lighting, the target pressure may be reduced so the temperature of the vapor cell does not need to be so high and still allow for an acceptable production of visible fluorescence. In the case that the atomic species is primarily composed of inert gases and metastable states, the target density can be reached at room temperature simply by controlling the pressure relative to the production efficiency of the metastable states, as discussed above.

As discussed above, inert gases can be at room temperature and achieve the target densities. With inert gases, collisional energy transfer will tend to remove atoms from the metastable manifold of states. For this reason, target pressures of on the order of 10 Torr are preferred in some embodiments (this corresponds to a metastable density of about 3×10¹³/cm³). Other embodiments may utilize a pressure in a range from 0.01 Torr to roughly 200 Torr.

For alkali atoms, the density is tied to the temperature of the gas. The relationship between density, pressure, and temperature may be calculated using the ideal gas law and species specific vapor pressure models (see, for example, [D. A. Steck, “Rubdium 87 D Line Data,” available online at http://steck.us/alkalidata (Revision 2.1.4, 23 Dec. 2010)]). Using these models, the target densities listed above can be converted to target pressures, as well as target temperatures. For example, in Rubidium, 10¹⁰-10¹⁶ atoms/cm³ correspond to a temperature range from 22° C. to 270° C. If the temperature of the Rb vapor is too high, then Rb—Rb molecules can be created—which may tend to corrupt the display. Consequently, temperatures above about 300° C. are not preferred.

The target density depends on a complex interplay of the excitation rate, the radiation trapping probability. This is discussed further below. If two alkali vapors are mixed in the display, they will each have a different density depending on the temperature of the display. For example, a mixture of Cesium and Rubidium will have partial pressures, and consequently densities, at a ratio from 3.5 to 2 over the temperature ranges listed above. Since the partial pressures of mixtures of inert gases can be controlled directly, any set of target densities can be produced without difficulty. In some implementations, to optimize the trade-offs, it may be preferable to utilize an atomic species which has heavy atoms and a large hyperfine splitting. For example, while naturally abundant Rb has an atomic mass of 85, Cs has an atomic mass of 133. The increased mass means that the Doppler profile increases more slowly with temperature so that higher temperatures (and corresponding densities) may be reached before the absorption profiles of the ground-state transitions begin to overlap. Cesium also has the advantage that the hyperfine splitting is 9.2 GHz, much larger than the 6.8 GHz splitting of Rb87 or the 3.2 GHz of Rb85. With Cesium vapors, the following transitions may be used:
the 6S_{1/2} level to the 6P_{3/2} level, then the 6P_{3/2} level to the 12-14D_{5/2} level;
the 6S_{1/2} level to the 6P_{1/2} level, then the 6P_{1/2} level to the 7-14D_{3/2} level;
the 6S_{1/2} level to the 6P_{1/2} level, then the 6P_{1/2} level to the 12-13S_{1/2} level;
the 6S_{1/2} level to the 6P_{3/2} level, then the 6P_{3/2} level to the 6D_{5/2} level which may decay to the 7P_{3/2} level via infrared radiation and subsequently to the 6S_{1/2} level via 455 nm radiation;
the 6S_{1/2} level to the 6P_{1/2} level, then the 6P_{1/2} level to the 6D_{3/2} level which may decay to the 7P_{1/2} level or the 7P_{3/2} level via infrared radiation and subsequently from these to the 6S_{1/2} level via radiation at 455 nm and 459 nm, respectively;
the 6S_{1/2} level to the 6P_{1/2} level via 895 nm laser light, then the 6P_{1/2} level to the 8S_{1/2} level via 761 nm light, which may decay to the 7P_{1/2} level or the 7P_{3/2} level via infrared radiation and subsequently to the 6S_{1/2} level via radiation at 455 nm and 459 nm, respectively; or
the 6S_{1/2} level to the 6P_{3/2} level via 852 nm laser light, then the 6P_{3/2} level to the 8S_{1/2} level via 794 nm laser light, which may decay to the 7P_{1/2} level or the 7P_{3/2} level via infrared radiation and subsequently to the 6S_{1/2} level via radiation at 455 nm and 459 nm, respectively.

If the gas is too dense, several deleterious effects can be noted. First, the light which is resonant with a ground-state (or metastable state) transition can become radiation trapped. For example, in the Rb vapor the 780 nm laser will tend to excite atoms up to the intermediate level. Additionally, atoms that are further excited to a high lying D_{5/2} level, say, may decay back down to the 5P_{3/2} level. In both cases, the atom will decay back down to the ground state by emitting photons that are resonant with the 5S_{1/2}-5P_{3/2} transition. If the vapor is too dense, this light will very quickly be reabsorbed. If the light is reabsorbed outside of the original beam of the 780 nm laser, it will mean that atoms outside the original 780 nm laser beam are able to absorb and emit the visible light. This will tend to lead to blurring and visual delocalization of the illumination voxel, for very high densities. In a configuration where the visible emission is resonant with a ground-state transition, the light will be absorbed and rescattered, blurring the illumination voxel even for more moderate densities. In the extreme case, the light emitted from the illumination voxel will be completely blurred—all that will be observed is a haze of light at the visible wavelength; the illumination voxel will not be observed at all.

If the gas is not dense enough then the vapor or gas will not be able to create a sufficient amount of visible fluorescence for the display to be viewed in even low to moderate ambient light settings.

In some embodiments, the optimal target density will depend on many factors. For example, if the temperature and density is too high, then atoms excited to the intermediate level can decay emitting resonant light which will then be radiation trapped and will have the effect of increasing the voxel size. The density can be higher when the transition generating the visible light is not connected to the ground state because the visible light won't be absorbed and rescattered as it leaves the cell.

In some embodiments, using an inert buffer gas in the vapor cell can lead to several improvements. A buffer gas has the effect of causing collisional broadening which broadens the effective atomic linewidth, allowing many more velocity classes to absorb laser light and emit radiation. In a hot vapor, the motion of atoms relative to the incoming optical beams causes the photons to be red- or blue-shifted for each atom based upon its velocity. If the optical beams have a very small bandwidth, then generally speaking, only those atoms that are nearly stationary will experience correctly detuned light. (In some cases, a so-called Doppler-free configuration can be implemented by counter-propagating the lower and upper excitation lasers. This only works in at least some instances when the lasers have nearly the same wavelength as is the case for the 5S_{1/2}-5P_{3/2} and 5P_{3/2}-5D_{5/2} levels. Additionally, without complex frequency chirping techniques, counter-propagating beams cannot give rise to a well-defined voxel tightly localized in all three dimensions.) This means that in some instances atoms having a large velocity will be less likely to be excited to higher levels. Consequently, the density of atoms in the excited state will be much smaller than expected. This means that the emitted radiation will be much reduced. The effect can be significant for even moderate temperatures. A measure of the effect can be calculated by comparing the width of the Maxwell velocity distribution to the width of the excited level. For example, in Rb vapor the Doppler width at 120° C. is approximately 600 MHz (FWHM), whereas the natural linewidths (again, FWHM) of the 5P_{3/2} and 5D_{5/2} levels are approximately 6 MHz and 0.7 MHz, respectively. Consequently, only about 1 in every 1000 atoms will interact with light resonant with the two-photon transition, reducing by the same factor of 1000 the population density of atoms in the excited state. By including a buffer gas, the homogeneous linewidth of the atoms can be increased by collisional broadening with the buffer gas. With an increased homogeneous linewidth, effect of the Doppler broadening can be much reduced. For example with 20 Torr of Neon buffer gas, the homogeneous linewidth of both intermediate and excited levels increases to about 200 MHz (FWHM), so that roughly 1 in every three atoms will interact with light resonant with the two-photon transition. This represents an increase of a factor of about 300 over the non-buffer gas cell. The optimal pressure of the buffer gas should be chosen to give rise to collisional broadening of somewhere in the range of 0.1 to 2 times the Doppler width. Different inert gas species can be used. For example, at approximately 120° C., Argon buffer gas imparts roughly 20 MHz/Torr of broadening, whereas Neon imparts roughly 10 MHz/Torr of broadening. One non-limiting embodiment may use 20 Torr of Neon buffer gas.

The net effect of the previous two improvements is roughly a factor of 15000 for a Rb vapor cell with 20 Torr Neon buffer gas. In some embodiments, the addition of buffer gas allows creation of a voxel that is easily viewed in normal room lighting with low power lasers (less than 30 mW power on target in each laser).

Another advantage in some embodiments to including a buffer gas is that the density of the atoms can be reduced and still be sufficient to create an acceptable amount of visible fluorescence. Reducing the density can drastically improve the problem of radiation trapping for visible light that is resonant with a ground state transition—this was mentioned briefly above. Since the total absorption (and subsequent reemission) of the visible fluorescence varies exponentially with the density, reducing the target density of the alkali vapor can drastically improve this problem in some instances.

Another advantage to including a buffer gas in some embodiments is that because the density can be reduced and still be sufficient to create an acceptable amount of visible fluorescence, the temperature can be reduced. This means that even the alkali vapor which requires heating can be considered viable in a practical implementation. Whereas temperatures of 160-180° C. appear to be optimal for the 5S-5P-5D based display, with a buffer gas temperatures of 80-100° C. may be acceptable. This drastically improves the electrical efficiency and reduces the possible danger of the 3D display.

In some embodiments, the illumination volume may include additional or alternative gasses or combinations of gasses. In some embodiments, multi-colored emissions may be achieved by using mixtures of different gases. For example, in some embodiments, for a red, green, and blue emission, three different gases may be included in the illumination volume/container, with different lasers driving those transitions.

### Illumination Volume

In the example shown in FIG. 1, the illumination volume 110 is the three dimensional space in which the first and second laser beams 122 and 132 may intersect in the atomic or molecular gas to form an image. The illumination volume 110 may be configured in a wide variety of geometries and sizes. In FIG. 1, the illumination volume 110 is a cube. In other embodiments, the illumination volume 110 may be cylindrical, spherical, or other shapes. The illumination volume 110 may have a volume on the order of cubic centimeters, cubic meters, or larger.

The illumination volume 110 may be located in a container, such as a vapor cell. In at least some embodiments, the atomic or molecular gas is evenly distributed throughout the container. The container (or at least some surfaces of the container) may be transparent or semi-transparent to provide unimpeded or relatively unimpeded viewing of images formed in the viewing volume 110 from multiple vantage points. In some embodiments, the container may be glass. In some embodiments, for example some embodiments utilizing gases that are introduced into the container under high vacuum, the container may be constructed from materials and in geometries to withstand high internal vacuum. In other embodiments, less robust containers may be employed (e.g., in some embodiments utilizing noble gases (e.g. helium, neon, argon, krypton, xenon, or radon), it may be possible to have the noble gas in the container at lower pressure, without evacuating the container to so-called high-vacuum pressures.

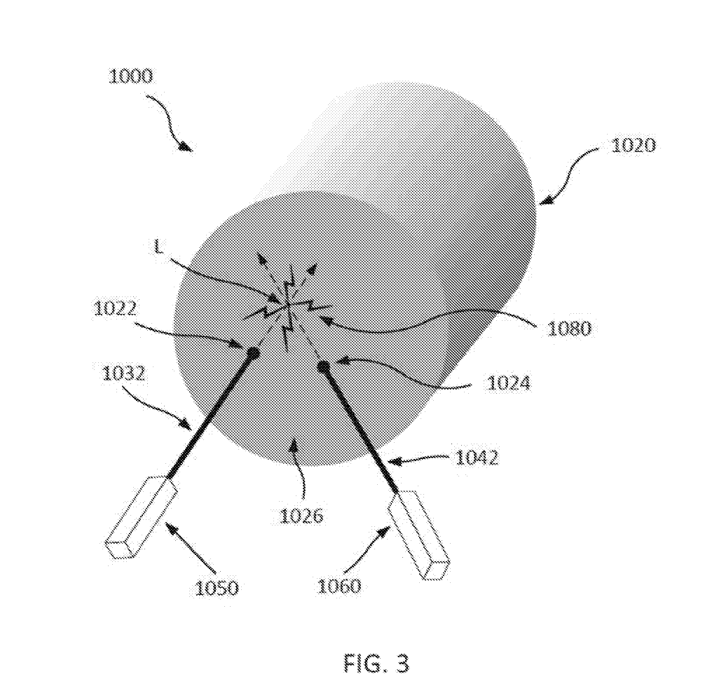

FIG. 3 shows one non-limiting example of a cylindrical container 1020. In FIG. 3, laser beam sources 1050, 1060 are positioned such that laser beams 1032, 1042 enter the container at points 1022, 1024, at a single side or face of the container (i.e., in this embodiment, a planar lower face of the cylinder). Cylindrical containers such as the one shown in FIG. 3 may be advantageous in some instances, as the curved wall of the cylinder will present fewer edges or corners in the container to interfere with the viewer's view of the illumination volume and image formed therein or otherwise distract the viewer. Cylindrical containers may also be advantageous as being better able to withstand vacuum pressures that may be applied to them in some instances.

Other embodiments may use other types of containers. For example, hemispherical or partial sphere (e.g. a sphere that has been truncated by a plane—such as a spherical cap or spherical bowl or inverted spherical bowl) containers could be employed. Such forms may also be able to withstand a large pressure differential with relatively thin glass. In some instances, the excitation lasers may enter the partial sphere through a flat surface in the same manner as which they enter a flat surface of a cylinder in some of the embodiments described above. Above the plane of the flat window of the partial sphere, no views of the fluorescence would be obstructed by glass corners. In some embodiments it may be advantageous to have two truncating planes and send one excitation through one plane and one laser through another plane. More generally, smooth glass surfaces, not necessarily spherical in shape, may be used above the flat entrance window or windows. As long as the glass above the flat window contains no sharp bends, it will induce minimal distortion to the emitted fluorescence. This freedom of the top surface above the flat window may enable designer shapes to be constructed. In still other embodiments, sharp bends or corners do not necessarily need to be avoided.

We describe further below methods for minimizing spurious intersections of the excitation lasers, which may be desirable in some, although not necessarily in all, embodiments. These techniques may or may not be employed with the additional use of dielectric coating and/or specially designed dichroic glass. For example, for a hemisphere container, a broadband antireflective coating can be given to the inside and outside of the hemisphere. This will permit the visible fluorescence to more easily be transmitted out of the container. Additionally, if the container is made from IR and UV absorptive glass, the excitation lasers that are infrared can be strongly absorbed by the glass with minimal reflections back into the main container. UV fluorescence generated by spurious decay pathways will also be absorbed by the glass. For example, Schott KG-1 Heat Absorbing Glass available from Edmund Optics strongly absorbs light below 300 nm and above 900 nm while transmitting visible wavelengths. Depending on the wavelengths of the excitation lasers, this glass could be very effective at reducing the laser and UV radiation reaching the user to safe levels. The display could be made out of other types of filters which are commercially available. Additionally, the display container could be enclosed in additional filtering enclosures so that the container itself might not be absorptive, but the additional enclosures are absorptive of UV and/or infrared light. In this way, any light that is dangerous to the user can be strongly attenuated to a safe level. It is important to note that in many embodiments the fluorescence generated by the illumination voxel will never be of sufficient intensity to endanger display users, even if it also contains unwanted ultraviolet fluorescence from undesirable decay pathways.

In some cases an absorptive structure may partially enclose the display volume at some distance. This could be used to ensure that a user is never able to view the display from a direction that the excitation lasers are able to point. For example, in a cylinder container, if the excitation lasers are restricted so that they only exit the container through the top window, an absorbing surface such as a black velvet cloth (or similar absorber which is safe at the powers of the excitation lasers) could be used in addition to anti-reflective coatings to block the excitation laser. The absorbing material could be put at a distance from the display, depending on the display design. The primary purpose, as stated previously, would be to ensure that no one is able to view the display from a possibly dangerous viewing angle.

FIG. 1 also shows an embodiment in which the laser beams 122, 132 can enter the illumination volume 110 through a single side or face (e.g. front face 111) of the illumination volume 110. By directing the laser beams through a single face, side or surface of the illumination volume 110, it is possible to construct a viewing display where the laser sources, scanning mechanisms, and other components of the display are situated out of view of the observer, for example in a cabinet under or behind the viewing volume. As shown here, the volume 110 also presents a top face 112, a bottom face 113, a right side face 114, a left side face 115, and a back face 116. As discussed elsewhere, the system 100 can be configured to change orientations in at least two degrees of freedom of both the first and second laser beams 122, 132 in the illumination volume 110 to change a location of the laser beam intersection in three dimensions.

In some embodiments, the illumination volume 110 constitutes the entire (or substantially entire) internal volume of the container. In other embodiments, the illumination volume 110 may be a subset of the internal volume of the container, even though the gas is distributed throughout the entire internal volume of the container. In other words, in some embodiments, there may be regions within the internal volume of the container where the system is not configured to generate images (or configured to avoid generating images). FIG. 1(a) schematically illustrates an example of a container 102′ and an illumination volume 110′ in which the illumination volume 110′ where images may be generated is smaller than the internal volume of the container 102′, with outer boundaries of the illumination volume 110′ being offset from the interior of the container 102′ by one or more distances (e.g. distance “d” in FIG. 1(a)). [0096] Restricting the illumination volume can also be used in some embodiments to ensure the safety of the display users. For example, in some of the embodiments utilizing cylinder and hemispherical containers, a smaller illumination voxel means that the deviation angle of the scanning lasers will be smaller. This may make it easier to add protective absorptive materials in a visually appealing way. For example, in the cylindrical container, restricting the illumination volume so that the lasers only exit the container through the far flat window would make it possible to put absorptive material only within the cone defined by location of the scanning mirrors and the cylinder far window. If the top of the cylinder were as tall as a person, then the absorptive material can be put at a large stand-off distance, possibly attached to the ceiling of the room in which the display is located. This would improve the visual appeal of the display. Other embodiments using partial spheres could also be made to have this property by ensuring the intersection of the excitation lasers and the container window is not visually accessible to the viewer.

In some embodiments, the system may be configured to minimize, if not eliminate, certain reflections of the laser beams 122, 132. As discussed above, visible light may be generated in the illumination volume 110 where first and second laser beams 122, 132 intersect (e.g. beam intersection 140 in FIG. 1). Reflections of one or both laser beams 122, 132 (such as by reflections off of surfaces of the container surrounding illumination volume 110) may result in laser beams 122, 132 following multiple trajectories within illumination volume 110 and potentially intersecting at more than location, potentially resulting in undesired or unintended light emissions within the illumination volume in addition to emissions at an intended location (e.g. other than light emission 150 in FIG. 1). In some embodiments, such reflections may be minimized, if not eliminated, by associating the container with anti-reflective properties. For example, in some embodiments, an anti-reflective film or other anti-reflective coating may be applied to one or more surfaces of the container that will minimize, if not eliminate, reflections of laser beams 122, 132.

In some embodiments, the proper use of anti-reflective coatings will depend on the particular frequencies present both in the fluorescence and in the excitation laser beams. They also depend upon the wavelengths and powers used in lasers in the display. The powers of lasers used in the display will depend upon an optimization over detuning, buffer gas pressure, and temperature that will need to be performed for each display medium. If the class II lasers give acceptable fluorescence brightness then no precautions need to be taken apart from warning the users not to look into a stationary laser beam. In fact, the primary danger is that users will look into a stationary beam. When the system is operating, the beams will be scanning over the volume and will not be stationary. The only risk then is that the system might malfunction and leave an excitation laser beam stationary in a visually accessible direction. If the design of the system is such that the laser beam can never be stationary in a direction that is accessible by the viewers, then much brighter beams can be used without risk to users. This is predominantly an engineering problem, and could be done using absorptive enclosures in the directions that the lasers propagate, or by building active feedback into the intensity modulation controls. For example, a signal could be generated which switches off the intensity control module if the pointing control signal remains stationary for too long. Alternatively, the scanning device can be made so that the beam angle goes in a non-accessible direction whenever there is a stationary, i.e. DC signal, received by the scanning module.

In some embodiments the anti-reflective coating can be made so that it transmits visible light but reflects infrared and ultraviolet light. This could be used to ensure that the excitation laser beams do not reach the viewers, in the case that the excitation lasers have either ultraviolet or infrared wavelengths, but no visible wavelengths. This approach is not necessarily advantageous in all embodiments because of the possibility of creating spurious fluorescence when the reflections of the excitation lasers intersect. An alternate approach would be to manufacture the container out of a substance that is absorptive for UV and IR wavelengths, but transparent for visible wavelengths. In the case where one or more of the lasers have visible wavelengths, then the aforementioned methods won't work. In this case the visible laser beams may need to pass through and out of the container in such a way that they are reliably absorbed and that they cannot be viewed directly by the display users. This may involve the combined use of anti-reflection coatings and absorptive enclosures or beam blocks. More generally, the container could have dichroic or multichroic anti-reflection and/or reflection coatings and/or absorptive regions to safely guide the light to a location where it will be absorbed and not endanger the display users.

In some embodiments, other aspects of the system may additionally or alternatively be configured to minimize or eliminate laser beam reflections through the illumination volume. For instance, by reducing the volume of the illumination volume relative to the container, and/or arranging the laser beams such that they enter the container from the same side or face of the container, the chance of laser beam reflections resulting in undesired secondary beam intersections can be reduced. FIGS. 1(b)-1(e) show a top view of a three-dimensional imaging system in which the container 102′, illumination volume 110′, and laser beam sources 120′ and 130′ are sized and arranged to minimize secondary beam intersections due to reflections of those laser beams inside the container. In this particular, and non-limiting, example, and as shown in FIG. 1(b), the container 102′ is a cube and the illumination volume 110′ is a smaller cube centered in the container (e.g. a cube occupying less than 50%, less than 25%, less than 10%, or other percentage of the total internal volume of the container). Laser beam sources 120′ and 130′ are arranged such that their beams will enter the container 102′ through the same side and can cover the entire illumination volume 110′ (in the top view) by scanning through 20 degree arcs (other arc ranges are also possible, depending on the scanning technology which is employed). In this non-limiting example, and as shown by the examples of possible laser beam reflection patterns in FIGS. 1(c)-(e), secondary intersections of the beams will not occur, at least prior to two or more reflections of one or both laser beams inside of the container.

In some instances, the container may be additionally or alternatively configured to minimize Fresnel reflections of laser beams as they pass through the container. FIG. 1(f) shows an example of a Fresnel reflection of a laser beam 122′ that may occur as it passes through the wall of a container 102′. FIG. 1(g) shows an example of a container 102′ that includes two spherically shaped windows 160′ and 160″ to suppress Fresnel reflections, with the spherical surfaces of the windows being arranged such that the laser beams are normal or approximately normal to the spherical surface where it passes into the container. In other instances, planar windows could be oriented to achieve approximately the same effect (e.g. oriented to achieve nearly normal entry angles for the laser beams). In at least some embodiments utilizing entrance windows to minimize Fresnel reflections, dielectric coatings may be provided on the windows to decrease reflection loss at the entrance window.

In other embodiments, the configurations and features illustrated by FIGS. 1(a)-1(g) are unnecessary, and other mechanisms may be employed to address reflection of laser beams (e.g. through anti-reflective coatings as discussed above) or otherwise account for laser beam reflection.

As mentioned above, some embodiments may include a heating system. The following is a non-limiting example of a heating system used with an experimental set up utilizing a cylindrical container embodiment. The cylinder may be mounted inside another glass cylinder that comprises the oven. In this non-limiting example, the oven cylinder has a diameter of 270 mm and a length of 10 inches, and the gas cylinder has a diameter of 200 mm and a length of 226 mm (about 9 inches). The gas cylinder is mounted about ¾ of an inch off the side of the oven cylinder. Beneath the gas cylinder are 6 resistive heating rods, each 5 inches long. Around each of the gas cylinder windows resistive heating rope is wrapped. In the oven windows, two small holes are drilled to accommodate the electrical wires for one, and to accommodate a brass hot air blowing tube. The hot air blowing tube has a diameter of about ⅜″ and blows super heated air into the oven. The super heated air goes down the tube and out small holes drilled at one inch spacing on the side of the brass tube. The little holes disperse the air so the heating is uniform. At each end of the brass tube are 4 holes drilled in the same position longitudinally which ensure that the gas cylinder windows are hotter than the sides of the gas cylinder. The super heated air is heated using inline resistive heater and is blown using a small pump. The total electrical power in the heating rods, rope, and heaters can run from 0 to near 700 W. The optimal electrical power, including the optimal ratio of electrical powers, has not been determined. The general principles guiding optimization are based upon the desired temperature and the requirement that the condensed Rubidium vapor not obstruct the excitation lasers or the primary viewing angles. This means that the coldest part of the vapor cell needs to be as hot as the desired temperature and should be in a region that does not obstruct either the excitation lasers or the primary viewing angles. The heater rope ensures that the windows can be made hotter than other parts of the cell, and heating from above with super-heated air ensures that the coldest part of the vapor cell is on the bottom of the cell. The heater rods on the bottom of the cell ensure that we can achieve the target temperature of the coldest part of the cell.

In some instances, scaling a 3D display up to larger sizes may create difficulties. For example, one difficulty is related to scaling the resolution of the display. Another difficulty is related to obtaining sufficient excited state atomic density in a large volume. We will first discuss the first problem.

The resolution problem with other 3-D systems has been noted elsewhere, for example, in Enhanced Visualization: Making Space for 3-D Images, by Barry G. Blundell [John Wiley and Sons, Hoboken, N.J., 2007]. This problem is somewhat independent of the absolute scale of the system. One difficulty is the amount of time available for a specific pair of excitation laser beams to visit all relevant voxels in the illumination region within the integration time scale of the eye. For example, for a frame rate of 24 Hz, each illuminated voxel in a frame should be visited once every 42 ms. If each voxel is illuminated for 250 ns then only about 168,000 individual voxels can be addressed in each frame. In a close-pack configuration, this would only correspond to roughly 55 pixels per side.

In some non-limiting embodiments of the present invention, systems and methods may incorporate 3D vector-scanning, which allows the effective resolution to be much larger. In some instances, for 3D vector-scanning the effective resolution is related to the total 2D surface area which can by drawn in the display. Since many 3D images are comprised of distinct surfaces separated by empty space, drawing only the surfaces can be a very efficient way of using the display because very little time is wasted directing the beams to voxels that are not illuminated.

In some non-limiting embodiments of the present invention, whether in combination with the vector-scanning technology discussed above or without that technology, buffer gas may be used to address the resolution issue. For example, assuming an optical pumping rate on the order of about 10 ns, the dwell time may be reduced in some instances to about 20 ns with little to no reduction in brightness. For this dwell time, in some instances, we can address 2.1 million individual voxels. For a close-pack configuration this corresponds to about 128 pixels per side, or in a 3D vector-scanning approach, to a total surface area of 1449×1449 pixels². This corresponds roughly to the same area as a 1080p HD TV. In a 3D vector scanning approach, this means that the resolution of each surface could be at or nearly at full HD resolution. The 3D vector-scanning resolution (in terms of total pixels) can be increased by a factor of 2 or more by increasing the laser power and the collisional broadening so the optical pumping time and laser dwell-time can be decreased by a factor of two or more. This would correspond to a collisional broadening of about 400 MHz. For collisional broadening much beyond this, we expect additional collisional broadening to begin to negatively affect the fraction of atoms that may be excited to the upper level due to the shortened lifetime of the atoms in the intermediate state. Nevertheless, in some non-limiting embodiments, a large fraction of atoms should still be able to be excited to the upper level. This means that, in some non-limiting embodiments, to reduce the cycle-time for the excitation decay process, one has to increase the optical pumping rate, which essentially means that the laser power should be increased. We expect that the additional cost associated with higher power lasers will put limits on how large the resolution may be scaled in some instances. Nevertheless, the continual progress in laser diodes, both in terms of availability, quality, and cost, suggest that this problem does not represent an insurmountable obstacle, but rather one that will be solved incrementally as laser diode technology continues to mature.

Another concern in some instances is obtaining sufficiently high atomic density so the display will be bright enough. For a display based upon a metal vapor such as Rubidium, one difficulty is to adequately heat the chamber and have it be safe for users. With the addition of buffer gas the heating requirement is drastically reduced in some instances. Additionally, in some embodiments, the vapor cell can be housed in transparent heater glass. Heater glass uses a 0.25 micron thick fluorine-doped tin oxide resistive coating which can be heated up to 176° C. This represents one possible method for uniformly heating the surface of a large glass enclosure. Combined with an evacuated glass enclosure, we think even large scale implementations (linear dimensions of 1-2 m) are possible.

With an inert gas, heating is not necessary in many embodiments though there is still difficulty in scaling to larger dimensions in some instances. For example, in some instances, one difficulty may be the effective lifetime of the metastable states in a low-pressure environment. Since the efficiency of creating metastable states by standard techniques is on the order of 1:10,000-100,000, the metastable states exist in an effective buffer gas of ground-state atoms. These ground state atoms lead to an increased quenching rate of the metastable states. The quenching rate depends on the pressure of the inert gas. Some sources list a few microseconds as a feasible effective metastable state lifetime. In some non-limiting embodiments, as long as the metastable states can propagate far enough in that short time to fill the display volume this method should be able to be used in larger volumes. An optimization can determine the trade-off between the density and the effective lifetime for each size of display. If the density must be reduced to fill the display, then the laser powers can increased to compensate.

### Lasers

The laser sources 120, 130 of the system shown in FIG. 1 may be selected based on the particular gas or gasses employed in the illumination volume 110. For example, in one embodiment that includes an atomic Rubidium gas in the illumination volume, lasers 120, 130 may include a laser configured to generate a 780 nm laser beam for exciting the 5S_{1/2}to the 5P_{3/2} transition and a laser configured to generate a 776 nm laser beam for exciting the 5P_{3/2} to the 5D5/2 transition in order to stimulate emission of a blue light at 420 nm.

One non-limiting embodiment uses scientific grade narrowband cw lasers (˜1-2 MHz bandwidth) with powers in the few tens of mW. In some instances, the fluorescence may be cleanest (in the sense of low blurring from fluorescence outside of the intersection volume) and brightest (for the level of voxel cleanliness) when the 780 nm laser is detuned away from the resonances of the D2 line. However, in some instances, we also find that due to the hyperfine splitting of the ground state, putting the 780 nm beam between the hyperfine resonances shows an improvement relative to putting it outside the resonances. This is because when the laser is between the resonances, it is equally likely to excite atoms out of either hyperfine state so that a preponderance of ground-state atoms do not develop in the hyperfine ground state which is less likely to be excited.

In one non-limiting embodiment, the optimal detuning for the 776 nm laser appears to be very close to or precisely at the two-photon detuning (meaning that the energy of both lasers add up to the energy difference between the top level and the bottom level.

In some non-limiting embodiments it will be the case that higher power lasers will produce better results, up until the saturation intensity is reached for a particular detuning. In these instances, additional power beyond that required for the saturation intensity doesn't contribute to the excitation process and is just wasted energy. There is the additional consideration of using as little light as possible so that the lasers pose less of a danger to the users. Finally, as the powers approach saturation, the fraction of atoms that may be excited relative to the increase in power decreases. Consequently, where possible, operating in the linear regime (below saturation) is relatively energy efficient. One difficulty in some instances of operating in a linear regime is that the power of the lower excitation laser is absorbed as it propagates through the vapor cell. This can mean, for example, that the intensity of the voxels at a distal location relative to the entrance window of the lasers can be reduced relative to proximate voxels. This may be corrected in some non-limiting embodiments by reducing the power of the upper excitation laser when addressing proximate voxels and increasing the power of the upper excitation laser when addressing distal voxels. The optimal power of the excitation laser for each voxel can be calibrated so that all voxels emit visible light with a uniform brightness or intensity. In some cases, the tradeoff between saving energy in the lower excitation laser by operating in the linear regime (below saturation) and having to attenuate the upper excitation laser to produce uniform brightness of the voxels may suggest that operating near or in the saturation regime for the lower excitation laser may be preferred.

In some instances, the optimal beam diameter may depend upon the expected viewing distance. The resolution of the eye is roughly equal to 90 microns when viewed at 1 foot [online: http://prometheus.med.utah.edu/˜bwjone/2010/06/apple-retina-display]. In embodiments intended to be comfortably view at about 2-3 feet, the beams may have a diameter on the order of 300 microns so as to exceed the resolution of the human eye. This can easily be accommodated by optical beams focused by lenses that are required to be at a moderate stand-off distance from the intersection point. Larger displays will be viewed from further away in some instances and will therefore tolerate a larger voxel size, allowing larger beam diameters. Larger beam diameters, in turn, will accommodate larger stand-off distances between the illumination region and the focusing lens. In some instances, larger beam diameters will also likely require increased laser power to compensate for the decreased laser intensity.

The system may include alternative and/or additional lasers for use with different gases, to produce different colors, to produce multi-color images, and/or for other purposes.

Lasers 120, 130 may be continuous or pulsed. In some instances, pulsed lasers (e.g. having a duration of milliseconds, microseconds, nanoseconds, picoseconds, or shorter or longer duration) may be utilized to enhance the absorption and visible emission and/or reduce the driving power of the laser.

In some instances, lasers may be intensity modulated to obtain intensity modulation (e.g., 8 bit gray scale) in the image or portions of the image.

With the inclusion of buffer gas, in some embodiments, lasers of moderate bandwidth may be employed. In some embodiments, the bandwidth of the laser diode should roughly match the collisional broadening width, or roughly 200-500 MHz. Diodes of this type may provide cost benefits. Additionally, in some non-limiting cases the bandwidth of the laser diodes can be increased beyond the requirements listed above. For example, if the system is operated in a true two-photon regime (as opposed to a sequential two photon absorption regime), then each laser bandwidth can be increased beyond what is stated above. As long as the bandwidths of the lower and upper laser are matched and appropriately tuned relative to one another, each region of the lower excitation laser bandwidth will contribute with the complementary region of the upper excitation bandwidth to produce true two photon excitation. Even in a sequential two photon absorption regime, an increased bandwidth can still contribute, albeit with a reduced efficiency, to promoting the atomic population to the intermediate state.

In some embodiments, the lasers should be have a bandwidth equal to the homogeneous linewidth (collisional broadening is included in the homogeneous linewidth) with a frequency stability which is on the order of or less than the homogeneous linewidth. In some cases active monitoring of the laser frequency and feedback will have to be used to ensure the laser frequencies do not drift over time. In other cases, larger bandwidths may be acceptable, and larger drifts may be tolerable, depending on the laser bandwidth and the size of the drift. In at least some implementations, these factors should be designed so as to reduce the variation of the brightness or intensity of the voxels over time to an acceptable level.

### Control System

The laser beam intersection 140 shown in FIG. 1 can represent an addressable location or position within the illumination volume 110, such that selective excitation of a small region of the atomic or molecular gas at an addressable location within the volume 110 operates to produce an illumination at that specific location. In some cases, an individual illumination can form at least part of an image. In some cases, a first intersection can produce a first illumination or illumination region and a second intersection can produce a second illumination or illumination region, such that the first and second illuminations or illumination regions form at least part of an image.

According to some embodiments, look up tables or algorithms can be used to correlate a desired xyz coordinate (or other addressable location) of the illumination volume with one or more angles (or other positioning or orienting information) for the laser beams. In some cases, xyz coordinates can be transformed into scan angles. For example, in the embodiment shown in FIG. 1, a particular xyz coordinate can be transformed into a first and second scan angle for the first laser beam 122 (e.g. a first scan angle about a first degree of freedom and a second scan angle about a second degree of freedom that is perpendicular or otherwise transverse to the first degree of freedom) and third and fourth scan angles for the second laser beam 132 (e.g. with the third scan angle being about one degree of freedom and the fourth scan angle being about another degree of freedom). In some embodiments, look up tables or algorithms may include information or otherwise be configured to relate a particular xyz coordinate or other spatial coordinate to settings or adjustments for scanning mechanisms used to adjust the first and second laser beams in multiple degrees of freedom.

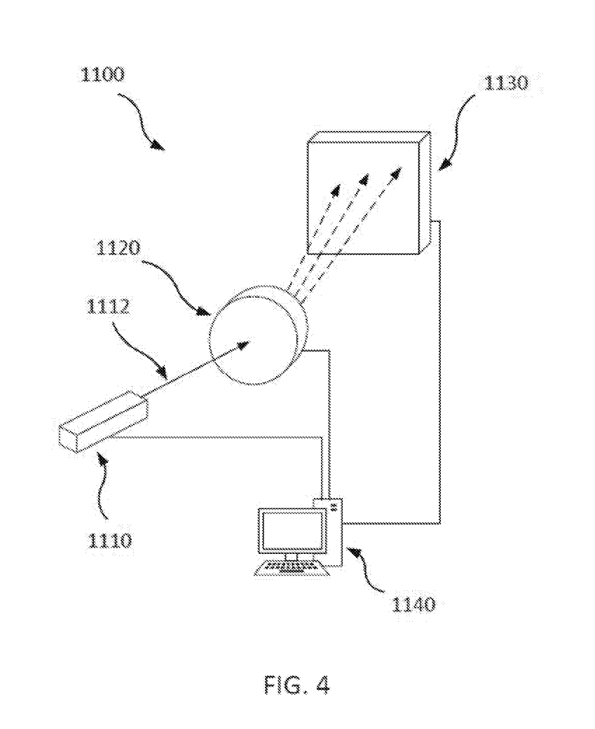

FIG. 4 depicts aspects of a display system 1100 according to another non-limiting embodiment of the present invention. As shown here, system 1100 includes a laser source 1110, a scanning mechanism 1120, a display 1130, and a control mechanism 1140 such as a computer or other processing device or system. Although a single laser source 1110 is shown in FIG. 4 for simplicity, it should be understood that this embodiment and others may include multiple laser sources.

The scanning mechanism 1120 may provide for the controlled deflection of a laser beam 1112 generated by the laser source 1110. Scanning mechanism 1120 may be one or more devices for scanning laser beam about one or more dimensions or degrees of freedom. According to some embodiments, the scanning mechanism 1120 can include any suitable configuration of moveable mirrors or diffractive structures to direct or spatially displace one or more laser beams in various degrees of freedom. In some cases, the scanning mechanism 1120 can direct a beam in one dimension or in one degree of freedom. In some cases, the scanning mechanism 1130 can direct a beam in two dimensions or two degrees of freedom. Exemplary mirror control mechanisms may include electric motors, galvanometers, piezoelectric actuators, magnetostrictive actuators, mems scanners, and the like. In some cases, a scanning mechanism 1120 can include acousto-optic deflectors and/or electro-optic deflectors. In some cases, a scanning mechanism may include a focus mechanism for adjusting the focal point of a beam along the beam path. In some cases, focusing can be implemented using an electrically-controlled variable-focus liquid lens. In some cases, focusing can be implemented using a servo-controlled lens. In some cases scanning technologies may be implemented sequentially, including a fast technology for small-scale deviations, and a large-scale scanning technology for large-scale deviations. In some cases this approach can increase the total deviation angle or arc without sacrificing scanning speed. An example of this type of embodiment would be an acousto-optical or electro-optical deflector followed by a galvanometer mirror scanner, possibly with intervening lenses.

In some embodiments, the focus may be controlled with spatial light modulators as well. Additionally, one of the two laser beams may be made to be elliptical or elongated along the y-axis. When the beams intersect at the origin of the display volume they naturally define a coordinate system. The bisecting angle in the plane of the two beams we call the x-axis (we define positive x to be beyond the origin relative to the shared direction of propagation of the two beams), the right-handed cross-product between the two laser beam propagation directions we call the y axis, and the z-axis is defined by the right-handed cross product of the x- and y-axes. In this coordinate system, with the beams at the origin, we make the beam longer along the y-axis relative to the width in the direction perpendicular to this axis. For example, we might make the diameter of the beam in the vertical direction roughly 1 mm, whereas in the horizontal direction it would only be about 300 μm. The other beam would be roughly 300 μm by 300 μm. Having one beam longer than the other in the y-direction makes it so that the system alignment is more robust with minimal effect on the voxel size. The voxel size is not increased because the voxel is controlled by the intersection of the two beams and this won't be strongly affected by lengthening one beam in the vertical direction. The system alignment is more robust because simpler transformations can be used to make the beams overlap. In practice determining the beam direction angles so that the laser beams overlap is a simple problem if the window through which they pass is not very thick. In some embodiments, because the window is quite thick it causes the beams to be translated slightly as they pass through the window. The translation depends upon the angle of incidence. Since the angle of incidence will be different for each beam a transformation done on the fly can become quite complex. In contrast by simply lengthening one of the beams, a simple transformation can be used which gives rise to minimal image distortion. Lengthening the beam also means that steering overshoot cannot cause dimming of the voxels in some embodiments. Alternatively, a look-up table with a list of corrective offset angles for given xyz positions may be used to compensate for translation of the beams due to the window glass. This can be done even when the lasers do not pass through a flat section of glass when entering the vapor cell.

In some embodiments, the system may include one or more tunable lenses. With a fixed focus approach the voxel size and brightness will naturally vary over the illumination region depending on the relative size of the beams at the beam intersection region. For example, when the intersection of the beams occurs away from the focus of either beam the voxel size will be increased and the brightness or intensity of the visible light may also be increased. When the intersection occurs near the focus of one beam the voxel can become elongated in one direction and have a reduced intensity or brightness. Incorporating a tunable lens into each beam may be used to ensure that the beams are always focused at the intersection region, which may be desirable in some, although not necessarily all, embodiments. Though the focus size will still vary slightly for near or far intersection locations, the change in the focus size can be drastically reduced, depending on the geometry of the non-tunable lens approach. For large illumination volumes, the stand-off distance of the final focusing optics from the illumination region may require the beam to have a sufficiently small divergence that a tunable lens will not offer a significant improvement in the variation of the focus size.

In some embodiments, intensity may be controlled with acousto-optical modulators. These may be fast enough to be used successfully with almost any scanning technology and exhibit high extinction ratios with relatively low loss. In other embodiments electro-optical modulators or other light modulating technology may be used.

In use, one or more scanning mechanisms can operate to create beam intersections within an illumination volume of the display 1130, such that the beam intersections occur at addressable locations of the illumination volume. By providing positional or direction control instructions from the processing device 1140 to a laser source, a scanning mechanism, and/or a display, it is possible to position a beam intersection at variable locations in three dimensions throughout the space of an illumination volume.

In some cases, raster scanning can be used to create the beam intersections at the addressable locations. In some cases, instructions for the laser source 1110, the scanning mechanism 1120, and/or the display mechanism 1130 can be provided via signals that are transmitted from a broadcasting entity, such as a television station, a cable service provider, an internet source or provider (e.g. via streaming media), or some other multimedia source. In other cases, information can be transmitted wirelessly from a processing device 1140 or from the via the internet or internet cellular connection.

Computer 1140 can be configured to provide or relay instructions to the scanning mechanism 1120. By changing the intensity and focal position (or beam-overlap position) of the light source, 3-dimensional color images can be produced in real space and changed in time. In this way, 3-dimensional videos can be generated.

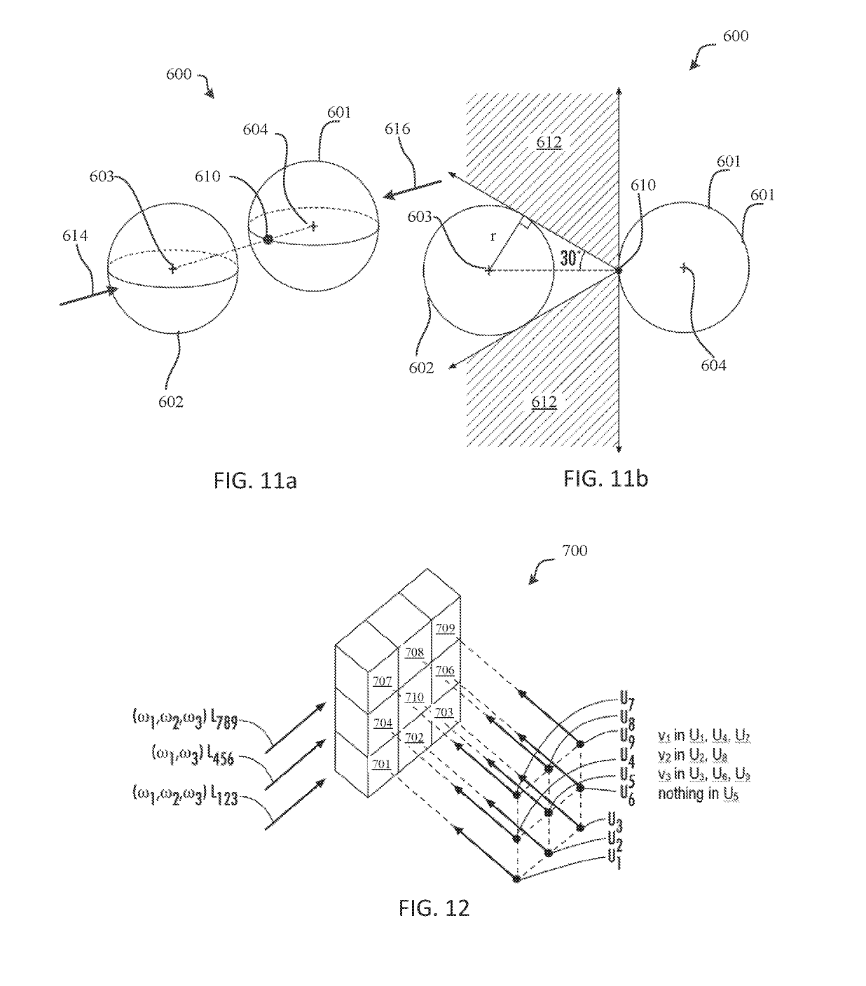

FIG. 5 depicts an example of a computer system or device 1200 (e.g., such as the computer or controller 1140 of FIG. 11) configured for use with a display system according to embodiments of the present invention. An example of a computer system or device 1200 may include an enterprise server, blade server, desktop computer, laptop computer, tablet computer, personal data assistant, smartphone, any combination thereof, and/or any other type of machine configured for performing calculations. The computer system or device 1200 may be configured to perform and/or include instructions that, when executed, instantiate and implement functionality of the laser source 1110, the scanning mechanism 1120, and/or the display 1130.

The computer 1200 of FIG. 5 is shown comprising hardware elements that may be electrically coupled via a bus 1202 (or may otherwise be in communication, as appropriate). The hardware elements may include a processing unit with one or more processors 1204, including without limitation one or more general-purpose processors and/or one or more special-purpose processors (such as digital signal processing chips, graphics acceleration processors, and/or the like); one or more input devices 1206, which may include without limitation a remote control, a mouse, a keyboard, and/or the like; and one or more output devices 1208, which may include without limitation a presentation device (e.g., controller screen).

The computer system 1200 may further include (and/or be in communication with) one or more non-transitory storage devices 1210, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 1200 can also include a communications subsystem 1212, which may include without limitation a modem, a network card (wireless and/or wired), an infrared communication device, a wireless communication device and/or a chipset such as a Bluetooth device, 802.11 device, WiFi device, WiMax device, cellular communication facilities such as GSM (Global System for Mobile Communications), W-CDMA (Wideband Code Division Multiple Access), LTE (Long Term Evolution), and the like. The communications subsystem 1212 may permit data to be exchanged with a network, other computer systems, controllers, and/or any other devices described herein. In at least some embodiments, the computer system 1200 can include a working memory 1214, which may include a random access memory and/or a read-only memory device, as described above.

The computer device 1200 also can include software elements, shown as being currently located within the working memory 1214, including an operating system 1216, device drivers, executable libraries, and/or other code, such as one or more application programs 1218, which may comprise computer programs provided by various embodiments, and/or may be designed to implement methods, and/or configure systems, provided by other embodiments, as described herein. By way of example, one or more system components might be implemented as code and/or instructions executable by a computer (and/or a processor, including an FPGA module, within a computer); in an aspect, then, such code and/or instructions may be used to configure and/or adapt a general purpose computer (or other device) to perform one or more operations.

A set of these instructions and/or code can be stored on a non-transitory computer-readable storage medium, such as the storage device(s) 1210 described above. In some cases, the storage medium might be incorporated within a computer system, such as computer system 1200. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 1200 and/or might take the form of source and/or installable code, which, upon compilation and/or installation on the computer system 1200 (e.g., using any of a variety of generally available compilers, installation programs, compression/decompression utilities, and the like), then takes the form of executable code.

It is apparent that substantial variations may be made in accordance with specific requirements. For example, customized hardware might also be used, and/or particular elements might be implemented in hardware, software (including portable software, such as applets, and the like), or both. Further, connection to other computing devices such as network input/output devices may be employed.

As mentioned above, in one aspect, some embodiments may employ a computer system (such as the computer device 1200) to perform methods in accordance with various embodiments of the disclosure. According to a set of embodiments, some or all of the procedures of such methods are performed by the computer system 1200 in response to processor 1204 executing one or more sequences of one or more instructions (which might be incorporated into the operating system 1216 and/or other code, such as an application program 1218) contained in the working memory 1214. Such instructions may be read into the working memory 1214 from another computer-readable medium, such as one or more of the storage device(s) 1210. Merely by way of example, execution of the sequences of instructions contained in the working memory 1214 may cause the processor(s) 1204 to perform one or more procedures of the methods described herein.

The terms “machine-readable medium” and “computer-readable medium,” as used herein, can refer to any non-transitory medium that participates in providing data that causes a machine to operate in a specific fashion. In an embodiment implemented using the computer device 1200, various computer-readable media might be involved in providing instructions/code to processor(s) 1204 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 1210. Volatile media may include, without limitation, dynamic memory, such as the working memory 1214.

The communications subsystem 1212 (and/or components thereof) generally can receive signals, and the bus 1202 then can carry the signals (and/or the data, instructions, and the like, carried by the signals) to the working memory 1214, from which the processor(s) 1204 retrieves and executes the instructions. The instructions received by the working memory 1214 may optionally be stored on a non-transitory storage device 1210 either before or after execution by the processor(s) 1204.

It should further be understood that the components of computer device 1200 can be distributed across a network. For example, some processing may be performed in one location using a first processor while other processing may be performed by another processor remote from the first processor. Other components of computer system 1200 may be similarly distributed. As such, computer device 1200 may be interpreted as a distributed computing system that performs processing in multiple locations. In some instances, computer system 1200 may be interpreted as a single computing device, such as a distinct laptop, desktop computer, or the like, depending on the context.

### Method

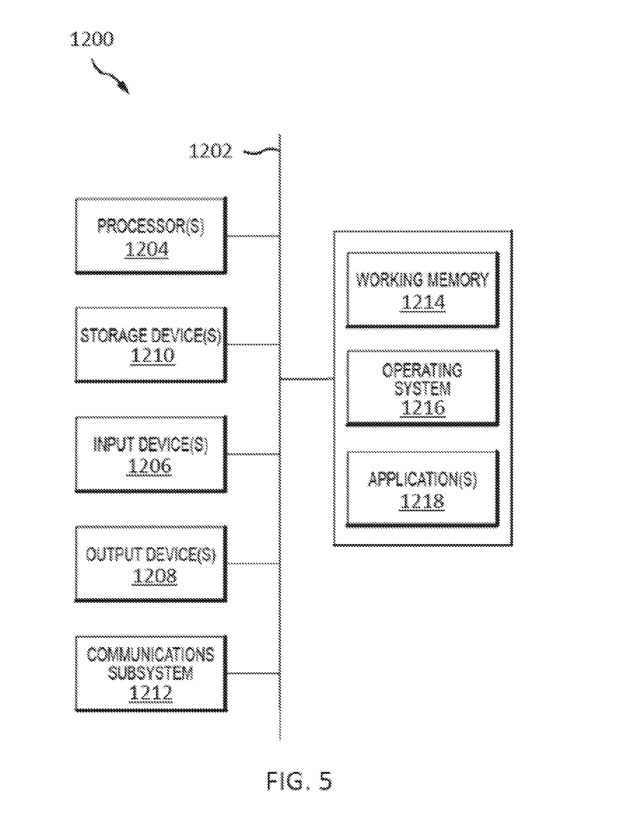

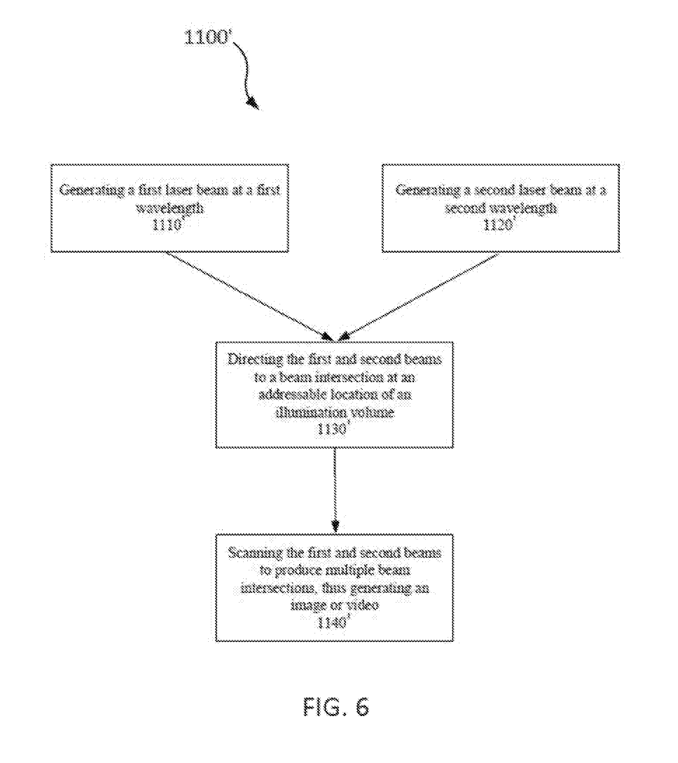

FIG. 6 depicts aspects of a display method 1100′ according to embodiments of the present invention. Method 1100′ may include generating a first laser beam at a first wavelength (e.g. using a first laser beam source), as depicted in step 1110′ and generating a second laser beam at a second wavelength (e.g. using a second laser beam source), as depicted in step 1120′. The first wavelength can be different from the second wavelength. The method can also include directing the first and second beams to an intersection at an addressable location of an illumination volume, as depicted in step 1130′. The illumination volume can include gaseous particles excitable by the first and second laser beams. Further, the method may include scanning the first and second beams, for example in at least two degrees of freedom, so as to produce beam intersections throughout the a three-dimensional space of the illumination volume, as indicated by step 1140′, so as to generate one or more static or dynamic images.

### EXAMPLE

The following non-limiting example is different from some of the other embodiments described above. Here, the approach uses true single-step two-photon excitation. The lasers copropagate, and only where the lasers have sufficient intensity does the two-photon absorption and subsequent fluorescence take place. The power is set so that the two-photon absorption occurs only in the focus region of the copropagating beams. The focus region is translated in the z-direction using the tunable lens and displaces in the x- and y-directions using the galvo scanners.

A small amount of Rubidium is added to 1 inch cubed cell under high vacuum. The cell is heated to obtain the desired atomic density (approximately 150° C.). One laser beam at 780 nm excites the 5S_{1/2} to the 5P_{3/2} transition. A second laser at 776 nm achieves the two-photon transition from the 5P_{3/2} to the 5D_{5/2} states. When the Rubidium atom is in the two-photon excited state, it can have a couple of spontaneous emission decay pathways, for example one spontaneous emission decay pathway emits a blue photon at 420 nm.

A fully variable scanning system is used to achieve a three dimensional moveable focus. In one dimension, an electrically-controlled variable-focus liquid lens is used. A galvo scanner is used to move the beam transversely. Each of these variable mechanical elements can operate with a scan rate of up to a few hundred Hertz, and can provide a full 3D movable focus effective to provide real-time 3D projection. The elements are controlled externally using a computer output.

In the direction of the focus, which can also be referred to as the z-axis, the expected resolution in this Example is set by the Rayleigh length, which is estimated at approximately 100 microns. The total z-axis viewing is approximately 1 cm. In the transverse dimension, the resolution is either set by the Galvo resolution or the focus beam width. It can be assumed that the resolution is set by the beam width, which is approximately 15 microns full width at half maximum. Using a conservative number, it is possible to estimate approximately 40 Megaregions or Megalocations for a 1 centimeter cubed viewing volume.

Additional implementations may include the use of three different gases in the cell, each with different lasers driving the respective energy transitions, so as to provide for red, green, and blue emission. To obtain intensity modulation (e.g., 8 bit gray scale) for each color, the lasers can also be intensity modulated. In some cases, rather than heating the cell, inert gases at the appropriate pressure can fill the cell. Very fast scanning, with no mechanical movement, can be achieved with acousto-optic deflectors. Pulsed beams can also greatly enhance the emission or reduce the driving power of the lasers.

### Controlling an Angular Intensity Pattern of an Illumination Voxel

For convincing interpretation of three dimensionality in 3D displays, visual depth cues may be incorporated into the display in some embodiments. These visual cues may include perspective, texture, lens accommodation, stereopsis, motion parallax, and many others. These cues may either be ignored or manufactured manually in 2D-projection based stereoscopic displays. In contrast, nearly all visual cues are naturally present in at least some implementations of the true-3D display with one exception—the absence of occlusion as a visual cue (e.g., the disappearance or brightness reduction of a light from a source when it passes through an opaque or semi-transparent foreground element). From a viewer's perspective, occlusion may be interpreted as an absence of or reduction in light from a source when behind a foreground element. Occlusion is absent in volumetric 3D display systems because voxels are typically transparent. This means that light emanating from illumination voxels will pass through all foreground voxels, including illuminated foreground voxels. For example, with an image of a human head in a fluorescence-based volumetric 3D display, a person would be able to see the distant ear through the face when viewing the head at certain angles. In at least some implementations, it would be preferable to address the problem of occlusion in a volumetric 3D display system. Additionally, in a volumetric display different viewers may have different notions of which elements should be viewable and which should be occluded. For an implementation of occlusion to be complete, it may be preferable if it is correct for all viewing angles. Accordingly, some embodiments of the present invention are generally related to methods and systems for controlling an angular intensity pattern of an illumination voxel. As an example, controlling an angular intensity pattern of an illumination voxel may include controlling or adjusting emission angles of the illumination voxel and/or intensity of emitted radiation along certain trajectories.

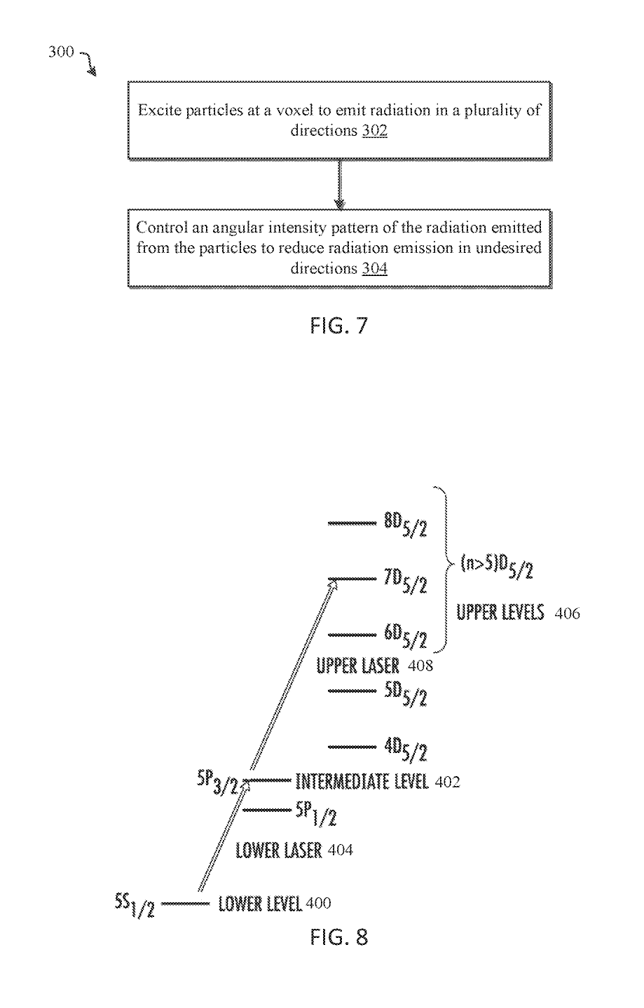

FIG. 7 illustrates an exemplary method 300 according to some embodiments of the present invention. At step 302, particles at a location may be excited to emit radiation in a plurality of directions. At step 304, an angular intensity pattern of the radiation emitted may be controlled to reduce radiation emission in undesired directions.

In some embodiments of the present invention, the angular emission pattern or angular intensity pattern may be controlled 304 when the light is generated 302. This may be implemented, for example, by using complex four-wave mixing process. Light will be emitted only in directions that are consistent with phase-matching conditions. In other embodiments, light may be emitted 302 in 4 pi steradian (4πsr) and then emitted radiation may be preferentially absorbed 304 so that the light transmitted adheres to a desired/calculated angular emission/intensity pattern.

The particles may be excited to emit radiation 302 using any of the methods and systems described herein. In a fluorescence-based 3D display, one implementation may be to illuminate the voxels of the volumetric medium sequentially in a 3D vector-scanning approach. This can be multiplexed on a small or large scale so that multiple, but not necessarily all, voxels are drawn at once. In some embodiments, a deformable mirror device (DMD) may be used to illuminate an entire plane of voxels. In some alternatives, sub-volumes of the total display volume may be specified and lasers may be dedicated to each of the sub-volumes. In this approach, each set of lasers for each sub-volume may perform a vector scanning or raster scanning of the sub-volume. In this way, the number of voxels that may be illuminated at one time can be reduced dependent on the scanning speed, illumination efficiency, and scanning path algorithm. The scanning path algorithm may determine an efficient vector scanning path through the 3D image to be presented in the display volume.

In some embodiments, a plurality of lasers may be intersected to excite particles (e.g., rubidium gas or the like) located at the intersection to a multi-photon state such that visible light is emitted from the beam intersection. The localized emission of radiation may have a ladder structure with a lower, intermediate, and upper level. One laser may promote the atoms from the lower level to the intermediate level and a second laser may promote the atoms from the intermediate level to the upper level. If the transition wavelength of the lower transition is in the infrared and the transition wavelength of the upper transition is in the visible, then the intersection of the two lasers will emit visible radiation into 4 pi steradians (4πsr) that propagates away from the illumination voxel. FIG. 8 illustrates a specific implementation of step 302. Particles of rubidium may be excited from a 5S_{1/2} state (lower state 400) to 5P_{3/2} level (an intermediate state 402) using a lower illumination laser 404. The particles of rubidium at the 5P_{3/2} level 402 may be excited to an (n>5)D_{5/2} level (upper levels 406) using an upper illumination laser 408.

The visual cue of optical occlusion may be provided by controlling the angular emission/intensity of each voxel in the volumetric medium 304. By controlling the angular emission/intensity of each voxel in the volumetric medium 304, the light reaching the viewer can be made to conform to the principle of optical occlusion.

For fluorescence-based volumetric displays with a single subvolume, the volumetric medium may be enclosed in a box or enclosure which is able to locally control the intensity of the transmitted light, hereafter referred to as a light valve array (LVA). Accordingly, in some embodiments, an enclosure may be constructed out of liquid crystal light valve arrays (e.g., such as those found in standard liquid crystal displays). By controlling the transmissivity of the light valve arrays during the illumination of each voxel, one can control the angular emission/intensity pattern 304 and thus implement optical occlusion. In some embodiments with a single subvolume there may only be one voxel illuminated at a single time. The light emitted by this voxel may be configured to conform to the principle of optical occlusion relative to the 3D image comprising the 3D video frame. The angular emission pattern can be controlled either locally, in the immediate vicinity of illuminated voxel, or where the light from the illuminated voxel leaves the illumination volume. In some embodiments, to conform an illumination voxel to the principle of optical occlusion, light emitted may be prevented from propagating to the viewing in a direction that is inconsistent with optical occlusion. In some embodiments, whether a direction is acceptable or not for a given illumination voxel may be determined ahead of time for each voxel in each frame of the 3D video or image. In some embodiments, when there is more than one subvolume, the emission pattern may be controlled in the local vicinity of each illumination voxel.

In further embodiments, occlusion voxels (or absorption voxels) may be created within the volumetric medium. This may be possible in a volumetric medium with multiple energy levels that are configured relative to the levels used to create fluorescence. Specifically, occlusion voxels may be generated by exciting particles to be resonant with the emitted radiation. A sufficiently high density of particles that are resonant with the emitted illumination radiation will cause the emitted illumination light to be absorbed and then remitted many times which will decrease the chances of the emitted illumination light propagating through the occlusion voxel. Accordingly, in some embodiments, one or more occlusion voxels may be generated adjacent illumination voxels and along undesired emission paths to modulate or adjust the emission angles and/or intensity of radiation from the illumination voxel. Strategic creation of the occlusion voxels about the illumination voxel may reduce light emission in undesired directions and/or intensities and may restrict light to propagate only in desired directions with the desired intensity.

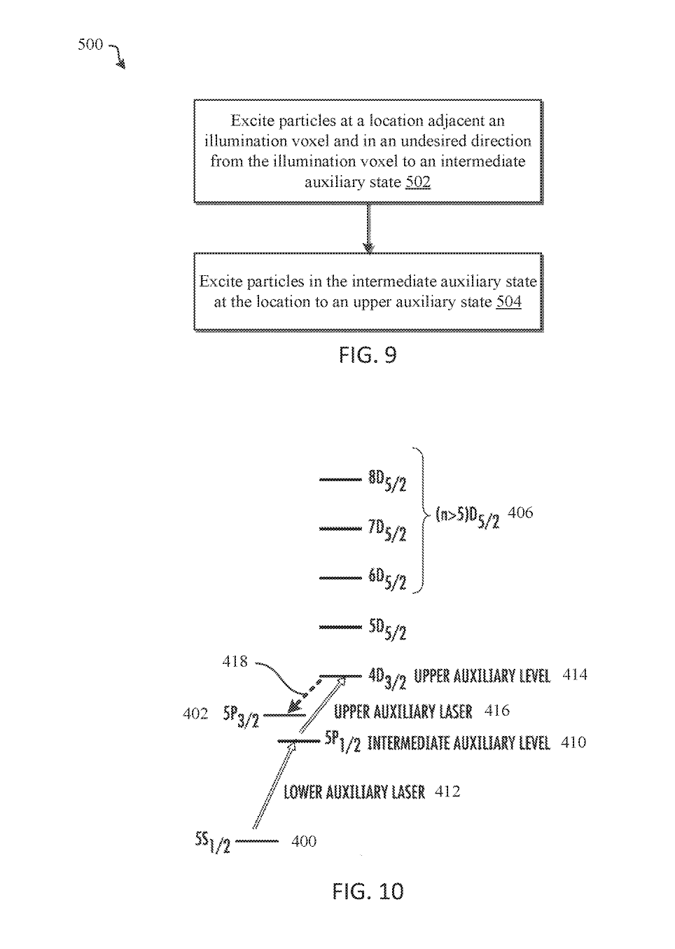

The occlusion voxels may be created by promoting the particles in the vicinity of the illumination voxel and in the undesired direction up into the intermediate state. If the density of particles in the intermediate state is sufficiently high, the light will not be able to propagate in the forward direction through the occlusion voxel. A laser resonant, or nearly resonant, with the lower transition of a two-photon absorption may be used to push the particles up into the intermediate level in some embodiments. Using a laser resonant with the lower transition may promote all particles in the beam to the intermediate level. Alternatively, to make a localized region with a high density of atoms in the intermediate level, additional auxiliary levels may be used. The auxiliary levels may include an intermediate auxiliary level and an upper auxiliary level. As with the illumination voxel, to create the occlusion voxel, two auxiliary lasers may intersect and push atoms up to the upper auxiliary level. Optionally, in some embodiments, atoms excited to the upper auxiliary level may decay from the upper auxiliary level to the intermediate level. FIG. 9 illustrates an exemplary method 500 of generating an occlusion voxel according to some embodiments. At step 502, particles adjacent an illumination voxel and in an undesired direction from the illumination voxel may be excited to an intermediate auxiliary state. At step 504, the particles at the intermediate auxiliary state at the location may be excited to an upper auxiliary state. In some embodiments, the particles may be excited to the intermediate auxiliary state by a first auxiliary laser. Particles at the intermediate auxiliary state may be excited to the upper auxiliary state by an upper auxiliary laser. Optionally, a one-step two-photon process using detuned lasers can promote atoms to the second auxiliary level without necessarily populating the first auxiliary level. This may be used for controlling the angular emission pattern by using detuning to keep some occlusion voxels transparent while neighboring occlusion voxels are made opaque.

Once in the upper auxiliary level, the particles may have a possibility of decaying to the intermediate level. Additionally, it may be preferable if the particles in the upper auxiliary level do not emit visible radiation when they decay. Additionally, a third laser nearly resonant with the transition between the intermediate level and the upper auxiliary level can be used in concert with the first two lasers to promote the transfer of population to the intermediate level. Accordingly, in some embodiments, two lasers (e.g., a lower auxiliary laser and an upper auxiliary laser), or more, may be used to excite particles adjacent an illumination voxel and in an undesired direction to the intermediate auxiliary level and the upper auxiliary level, respectively. Thus, in some embodiments, only atoms in the intersection of the auxiliary beams will be pushed into the upper auxiliary level and will possibly decay to the intermediate level. Consequently, in some embodiments, particles may be moved to the intermediate level in a localized manner. Once in the intermediate level, the atoms may absorb and reemit the radiation coming from the illumination voxel. With a sufficient density of particles in the intermediate level, the emitted radiation from the illumination voxel will be prevented from propagating in the undesired direction. Thus, one or a plurality of auxiliary lasers may be provided to produce occlusion/absorption voxels in the illumination volume for controlling light emission/intensity patterns according to some embodiments of the present invention.

FIG. 10 illustrates a specific implementation of method 500. Particles of Rubidium may be excited from a 5S_{1/2} state (lower state 400) to 5P_{1/2} level (an intermediate auxiliary state 410) using a lower auxiliary laser 412. The particles of rubidium at the 5P_{1/2} level 410 may be excited to an upper auxiliary level 4D_{3/2} (upper auxiliary level 414) using an upper auxiliary laser 416. When in this upper auxiliary level 414, the particles may have a chance (approximately 15%) of decaying 418 to the 5P_{3/2} level 402. Advantageously, the atoms in the upper levels 406 ((n>5)D_{5/2}) cannot decay to the P_{1/2} level 410. This may be beneficial because it means that the illumination lasers (e.g., lasers 404, 408) will not accidentally populate the intermediate auxiliary level 410.

FIG. 11a-11b illustrate an exemplary 3D display state 600 for the purpose of illustrating occlusion principles and methods and systems of the present invention. FIG. 11a shows a perspective view of the display of two opaque spheres 601, 602 of equal radius r. FIG. 11b illustrates a side view of the exemplary situation 600. The centers 603, 604 of the spheres 601, 602 are displaced by three times their radius, r, in a horizontal direction. The voxel 610 of sphere 601 may be the voxel of sphere 601 that is closest to sphere 602. The angular coordinates for this voxel 610 are defined with the zenith in the vertical direction and the direction corresponding to zero azimuthal angle defined by a line segment connecting the voxel 610 to the center 604 of the sphere 602. The polar angle is defined as theta (θ) and the azimuthal angle is defined as phi (ϕ). From the side view in FIG. 11b, in order to adhere to the principle of optical occlusion in this exemplary situation, light emitted from voxel 610 should only propagate in the angular region where theta (θ) is greater than 30 degrees but less than 90 degrees, with phi (ϕ) unconstrained. Accordingly, in the illustrated example, voxel 610 may emit radiation only into the shaded region 612. This specification of angles may be an angular emission pattern for the specified voxel 610. In this way, light from the specified voxel 610 will never be perceived as transmitting through an opaque surface of sphere 601 or sphere 602. For a particular 3D image, each voxel may have a unique angular emission pattern that adheres to the principle of optical occlusion. Thus, a fluorescence-based 3D display that is able to control the angular emission pattern of each voxel may be able to fully implement optical occlusion. In the case that the foreground element (e.g., sphere 602 when viewed along axis 614) is semi-transparent as opposed to fully opaque, it may be sufficient to be able to control the angular intensity pattern of the illumination voxel. With a 3D display, many different viewers or view perspectives may be provided. For an implementation of occlusion to be complete, it may be preferable if occlusion is correct for all viewing angles. Accordingly, in some embodiments, it may be preferable to calculate and control angular emission intensity and/or angles for each of the illumination voxels defining sphere 601 in addition to the illumination voxels defining sphere 602.

To implement control over the full emission pattern, the transmission properties of each emission direction may be controlled independently. In some embodiments, the direction of the illumination laser nearly resonant with the upper transition may be ignored because, for laser safety reasons, the laser will not be along a viewing direction. To independently control all of the emission directions independently, spatial and frequency dependent multiplexing can be used. For simplicity FIG. 12 illustrates a 2D cross-section 700 through the illumination voxel 710 that is perpendicular to one of the illumination lasers. Additionally, assume that the two illumination lasers for exciting the particles in the illumination voxel 710 are perpendicular. As illustrated in the cross-section 700, voxels 701, 702, 703, 704, 706, 708, and 709 are adjacent to the illumination voxel 710 that lie in this cross-section 700. In the exemplary system illustrated, the lower auxiliary laser beams L₁₂₃, L₄₅₆, L₇₈₉ propagate through the rows for the lower auxiliary transition (e.g., level 400 to level 410) and the upper auxiliary laser beams U₁, U₂, U₃, U₄, U₆, U₇, U₈, and U₉ propagate down into the voxels 701, 702, 703, 704, 706, 708, and 709 for the upper auxiliary transition (e.g., level 410 to level 414). This means there may be three beams in the lower auxiliary laser and eight beams on the upper auxiliary laser. The three beams in the lower auxiliary laser may be L₁₂₃, L₄₅₆, and L₇₈₉, where the indices indicate the beam path and the eight beams in the upper auxiliary laser may be U₁-U₉, omitting U₅.

In the L₁₂₃ and L₇₈₉ beams, three distinct frequencies ω₁, ω₂, ω₃ of light nearly resonant with the lower auxiliary transition (e.g., lower auxiliary transition from level 400 to level 410) may be sent. In the L₄₅₆ beam, two distinct frequencies ω₁ and ω₃ may be sent. In U₁, U₄ and U₇, light with frequency v₁ may be sent, where ω₁+v₁ is resonant or nearly resonant with the energy difference between the ground state (e.g., state 400) and the upper auxiliary level (e.g. level 414) or the ground to upper auxiliary level two-photon transition. In U₂ and U₈ light with frequency v₂ may be sent, where ω₂+v₂ is resonant or nearly resonant with the ground to upper auxiliary level two-photon transition. Furthermore, in U₃, U₆, and U₉, light with frequency v₃ may be sent, where ω₃+v₃ is resonant or nearly resonant with the ground to upper two-photon transition. With independent control over the power in each frequency and in each spatial mode, the voxels 701, 702, 703, 704, 706, 708, and 709 may be selectively made absorptive/occlusive. For example, to make voxel 701, 706, and 708 absorptive, laser powers corresponding to L₁₂₃ω₁ and U₁v₁; L₄₅₆ω₃ and U₆v₃; and L₇₈₉ω₂ and U₈v₂ may be turned on. Alternatively, to make voxel 701 and 703 and 706 absorptive, laser powers according to L₁₂₃ω₁ and U₁v₁; L₁₂₃ω₃ and U₃v₃; L₄₅₆ω₃ and U₆v₃ may be turned on.

With this understanding it should be clear that all voxels 701, 702, 703, 704, 706, 708, and 709 in the cross-section 700 can be independently controlled by calculating and adjusting the powers and lasers directed at the cross section 700.

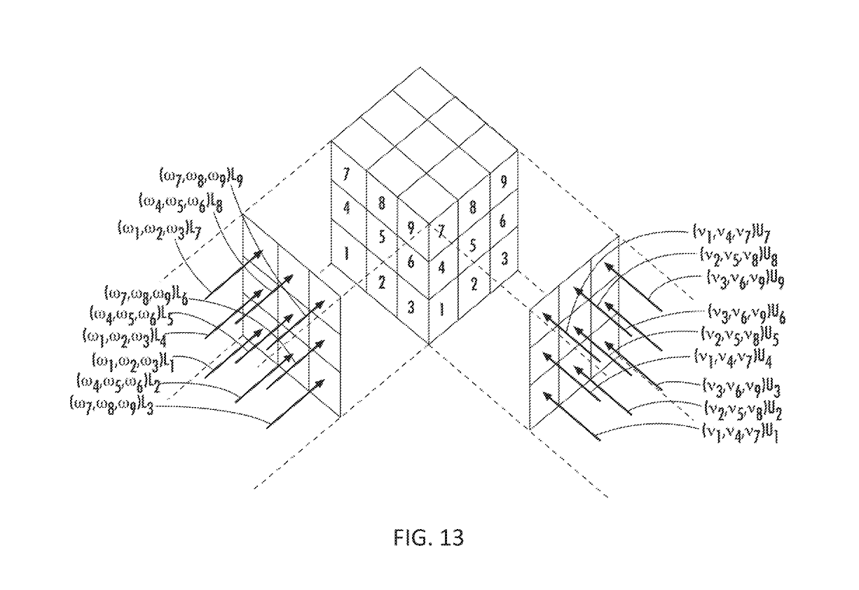

This approach can be generalized to three dimensions. For example, FIG. 13 illustrates a 3×3×3 cube of voxels surrounding an illumination voxel. In this case 9 lasers may be used in each beam which are labeled (L₁-L₉) and (U₁-U₉). The illumination lasers may copropagate with the L₅ and U₅ auxiliary lasers. Each beam may include three laser frequencies in three spatial groups, for example, L₁, L₄, and L₇ may each carry the following three frequencies ω₁, ω₂, and ω₃. Additionally, L₂, L₅, and L₈ may each carry ω₄, ω₅, and ω₆. L₃, L₆, and L₉ may each carry ω₇, ω₈, and ω₉. In contrast, the upper auxiliary laser may carry the corresponding frequencies to isolate the voxels in the orthogonal direction: U₁, U₄, and U₇ may each carry v₁, v₄, and v₇; U₂, U₅, and U₈ may each carry v₂, v₅, and v₈; and U₃, U₆, and U₉ may each carry v₃, v₆, and v₉.

Similar to the above example, ω₁+v₁ is resonant or nearly resonant with the ground to upper auxiliary level two-photon transition; ω₂+v₂ is resonant or nearly resonant with the ground to upper auxiliary level two-photon transition; ω₃+v₃ is resonant or nearly resonant with the ground to upper auxiliary level two-photon transition; ω₄+v₄ is resonant or nearly resonant with the ground to upper auxiliary level two-photon transition; ω₅+v₅ is resonant or nearly resonant with the ground to upper auxiliary level two-photon transition; ω₆+v₆ is resonant or nearly resonant with the ground to upper auxiliary level two-photon transition; ω₇+v₇ is resonant or nearly resonant with the ground to upper auxiliary level two-photon transition; ω₈+v₈ is resonant or nearly resonant with the ground to upper auxiliary level two-photon transition; and ω₉+v₉ is resonant or nearly resonant with the ground to upper auxiliary level two-photon transition.

Voxels may be identified, for example, by their spatial coordinate pair. Only those frequencies which complete the two-photon transition may be turned on. For example, the voxel at the intersection of L₁ and U₂ may be made absorptive by turning on the L₁ω₂ and U₂v₂ beam. The voxel at the intersection of L₃ and U₂ may be made absorptive by turning on the L₃ω₈ and U₂v₈ beam. The voxel at the intersection of L₂ and U₁ may be made absorptive by turning on the L₂ω₄ and U₁v₄ beam. The voxel at the intersection of L₂ and U₃ may be made absorptive by turning on the L₂ω₆ and U₃v₆ beam. Notably, even with all of the voxels at the intersections of L₁ and U₂; L₃ and U₂; L₂ and U₁; and L₂ and U₃ absorptive, the voxel at the intersection of L₂ and U₂ may be left transmissive because none of the light flowing through that voxel can complete the two-photon transition. Specifically, the light propagating through the voxel at the intersection of L₂ and U₂ contains the following frequencies, ω₄, ω₆, v₂, and v₈ but the sum of any pair of these cannot complete the two-photon transition. In general, each occlusion voxel can be made absorptive or transmissive independently. In practice, the ω₅ and v₅ frequencies may not need to be turned on since they correspond to the position of the illumination voxel (at the center of the illustrated 3×3×3 volume). In some embodiments, they can be omitted from the system.

The previous example shows how the emission pattern can be controlled coarsely. By increasing the number of occlusion voxels from 3×3×3 to larger dimensions and/or by possibly including alternate geometry such as hexagonal packing of the beams, etc., the emission pattern can be controlled with improved angular resolution. Accordingly, systems and methods are provided herein for controlling an angular intensity pattern of an illumination voxel. Systems may utilize one or more auxiliary lasers for exciting particles to the intermediate level. For creating localized occlusion voxels, systems and methods may utilize a plurality of auxiliary lasers and the plurality of auxiliary lasers may be configured to send beams of varying frequency so as to selectively control whether voxels are absorptive or transmissive. Thus, emission angles/intensities for each of the illumination voxels in a volumetric 3D display may be calculated. Occlusion/absorption voxels may then be generated using methods and systems disclosed herein to address the problem of optical occlusion in the volumetric 3D display.

In some embodiments, the angular intensity/emission pattern may only be controlled in directions where the light may eventually be viewed by a user. For example, in some cases, for a given voxel there may be barriers restricting visual accessibility by a viewer in some directions. Accordingly, it may not be necessary to control the angular intensity/emission pattern in these directions. For example, if the illumination volume is sitting on top of an opaque surface (e.g., table or stand or the like) so that the light propagating in the downward direction toward the surface is not viewable, a large region of the 4\pi steradians need not be calculated or controlled. This may drastically simplify some of the complexity, calculations, and processing needed to address the problem of optical occlusion in the volumetric 3D display.

Each of the calculations or operations described herein may be performed using a computer or other processor having hardware, software, and/or firmware. The various method steps may be performed by modules, and the modules may comprise any of a wide variety of digital and/or analog data processing hardware and/or software arranged to perform the method steps described herein. The modules optionally comprising data processing hardware adapted to perform one or more of these steps by having appropriate machine programming code associated therewith, the modules for two or more steps (or portions of two or more steps) being integrated into a single processor board or separated into different processor boards in any of a wide variety of integrated and/or distributed processing architectures. These methods and systems will often employ a tangible media embodying machine-readable code with instructions for performing the method steps described above. Suitable tangible media may comprise a memory (including a volatile memory and/or a non-volatile memory), a storage media (such as a magnetic recording on a floppy disk, a hard disk, a tape, or the like; on an optical memory such as a CD, a CD-R/W, a CD-ROM, a DVD, or the like; or any other digital or analog storage media), or the like.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method of creating a three dimensional image in a three dimensional illumination volume comprising at least one gas, the method comprising:
intersecting at least two lasers at a first voxel in the illumination volume such that particles at the first voxel emit radiation in a plurality of directions from the first voxel;
exciting particles at one or more second voxels in the illumination volume to an intermediate state that absorbs at least a portion of the emitted radiation in at least one of the directions of the emitted radiation.

2. The method of claim 1, wherein exciting particles at the one or more second voxels to the intermediate state comprises using at least one laser to excite the particles to the intermediate state.

3. The method of claim 1, wherein exciting particles at the one or more second voxels to the intermediate state comprises using at least two lasers to excite the particles to the intermediate state.

4. The method of claim 3, wherein exciting particles at the one or more second voxels to the intermediate state comprises exciting the particles to a lower auxiliary state by a first auxiliary laser beam and exciting the particles to an upper auxiliary state by a second auxiliary laser beam, the excited particles at the one or more second voxels decaying from the upper auxiliary state to the intermediate state.

5. The method of claim 4, wherein the excited particles at the one or more second voxels do not emit visible light when the particles decay from the upper auxiliary state to the intermediate state.

6. The method of claim 4, wherein the at least one gas comprises Rubidium gas;
wherein the particles at the first voxel are excited by a first illumination laser beam exciting Rubidium particles from a 5S_{1/2} level to a 5P_{3/2} level and a second illumination laser beam exciting Rubidium particles from the 5P_{3/2} level to an (n>5)D_{5/2} level;
wherein the particles at the one or more second voxels are excited to a 5P_{1/2} level by the first auxiliary laser beam and are excited to a 4D_{3/2} level by the second auxiliary laser beam.

7. The method of claim 6, wherein a portion of the particles excited to the 4D_{3/2} level decay to the 5P_{3/2} level.

8. The method of claim 1 further comprising, calculating a desired angular intensity pattern.

9. A method for implementing optical occlusion in a three dimensional imaging system, the method comprising:
generating an illumination voxel emitting radiation in a plurality of directions, the illumination voxel being behind a foreground element when viewed from a first perspective along a first viewing axis;
dynamically controlling an angular intensity pattern of the radiation emitted from the illumination voxel such that radiation emitted by the illumination voxel toward the foreground element along the viewing axis is attenuated.

10. The method of claim 9, wherein the foreground element comprises a plurality of foreground element illumination voxels.

11. The method of claim 10, wherein the foreground element illumination voxels are generated by intersecting two or more laser beams at locations of each of the foreground element illumination voxels within a container of gas.

12. The method of claim 10, further comprising dynamically controlling angular intensity patterns of the plurality of foreground element illumination voxels.

13. The method of claim 9, wherein the illumination voxel is generated in an enclosure, wherein the enclosure is configured to locally control the intensity of transmitted radiation through the enclosure.

14. The method of claim 9, wherein the enclosure comprises liquid crystal light valve arrays and wherein dynamically controlling the angular intensity pattern of the illumination voxel comprises controlling the liquid crystal light valve arrays of the enclosure to adjust transmittivity during illumination voxel generation.

15. The method of claim 9, wherein dynamically controlling the angular intensity pattern of the illumination voxel comprises exciting particles between the illumination voxel and the foreground element along the viewing axis to an intermediate state configured to absorb at least a portion of radiation emitted by the illumination voxel along the viewing axis.

16. The method of claim 15, wherein particles between the illumination voxel and the foreground element along the viewing axis are excited to the intermediate state by intersecting two or more laser beams to excite a localized region of particles to the intermediate state.

17. A three dimensional display system comprising:
a three dimensional illumination volume comprising at least one gas configured to emit a visible light when excited from a ground state to a multi-photon excited state;
a first illumination laser configured to generate a first illumination laser beam;
a second illumination laser configured to generate a second illumination laser beam;
a first auxiliary laser configured to generate a first auxiliary laser beam;
a second auxiliary laser configured to generate a second auxiliary laser beam;
the system configured to direct the first illumination beam and the second illumination beam into the illumination volume such that the first illumination beam and the second illumination beam intersect in the illumination volume to excite at least some particles of the gas at the intersection of the first illumination beam and the second illumination beam to the multi-photon excited state such that visible light is emitted at the intersection of the first illumination beam and the second illumination beam;
the system further configured to direct the first auxiliary beam and the second auxiliary beam into the illumination volume such that the first auxiliary beam and the second auxiliary beam intersect in the illumination volume to excite at least some particles of the gas at the intersection of the first auxiliary beam and the second auxiliary beam to an intermediate level such that at least a portion of the visible light emitted at the intersection of the first illumination beam and the second illumination beam is absorbed by the particles of the gas at the intersection of the first auxiliary beam and the second auxiliary beam excited to the intermediate level.

18. The three dimensional display system of claim 17, wherein the first auxiliary laser is configured to generate the first auxiliary laser beam at a first auxiliary frequency and wherein the second auxiliary laser is configured to generate the second auxiliary laser beam at a second auxiliary frequency, wherein the first auxiliary frequency in addition to the second auxiliary frequency are resonant with an energy difference between the ground state and the multi-photon excited state.

19. The three dimensional display system of claim 18, wherein the first auxiliary laser is configured to excite particles to a first auxiliary level and wherein the second auxiliary laser is configured to excite particles from the first auxiliary level to a second auxiliary level, and wherein a portion of the particles excited to the second auxiliary level decay to the intermediate level.

20. The three dimensional display system of claim 19, wherein the volume of gas comprises Rubidium gas;
wherein the first illumination laser beam is configured to excite Rubidium particles from a 5S_{1/2} level to a 5P_{3/2} level;
wherein the second illumination laser beam is configured to excite Rubidium particles from the 5P_{3/2} level to an (n>5)D_{5/2} level;
wherein the first auxiliary laser beam is configured to excite Rubidium particles to a 5P_{1/2} level; and
wherein the second auxiliary laser beam is configured to excite Rubidium particles from the 5P_{1/2} level to a 4D_{3/2} level.
